(19) United States
(12) Patent Application Publication
(10) Pub. No.: US 2026/0267213 A1
(43) Pub. Date: Sep. 10, 2026

(54) IMAGE FORMING METHOD, IMAGE FORMING APPARATUS, AND IMAGE FORMING PROGRAM

(71) Applicant: FUJIFILM Corporation, Tokyo (JP)

(72) Inventor: Hiroyuki YONEYAMA, Tokyo (JP)

(73) Assignee: FUJIFILM Corporation, Tokyo (JP)

(21) Appl. No.: 19/675,206

(22) Filed: May 12, 2026

Related U.S. Application Data
(62) Division of application No. 17/346,982, filed on Jun. 14, 2021.

(30) Foreign Application Priority Data
Jun. 15, 2020 (JP) 2020-103263

(51) Int. Cl. G03C 7/30; G03C 1/005; G03C 7/305

(52) U.S. Cl. CPC G03C 7/3022; G03C 1/005; G03C 7/3041; G03C 7/30576; G03C 2007/3044; G03C 2007/30588

(57) ABSTRACT

There are provided an image forming method, an image forming apparatus, and an image forming program capable of giving a temporal change to an observation image by intentionally providing a time difference between image appearance recognition timings for a plurality of regions of the observation image. There is provided an image forming method of forming an observation image by exposing a photographic photosensitive material using an input image and performing development processing. The observation image includes an image A of a first image region in which the image appearance recognition timing after a start of development processing is relatively earlier and an image B of a second image region in which the image appearance recognition timing after a start of development processing is relatively later. First, two original images are acquired, and a first original image and a second original image respectively corresponding to the first image region and the second image region are determined. For the first original image and the second original image, a first drawing condition that satisfies a condition of the image appearance recognition timing of the first image region and a second drawing condition that satisfies a condition of the image appearance recognition timing of the second image region are created. The input image which is to be used for forming the observation image is generated based on the first original image, the first drawing condition, the second original image, and the second drawing condition.

### CROSS-REFERENCE TO RELATED APPLICATION

This application is a Continuation of U.S. patent application Ser. No. 17/346,982 filed on Jun. 14, 2021, which claims priority under 35 U.S.C § 119 (a) to Japanese Patent Application No. 2020-103263 filed on Jun. 15, 2020, which is hereby expressly incorporated by reference, in its entirety, into the present application.

### BACKGROUND OF THE INVENTION

### 1. Field of the Invention

The present invention relates to an image forming method, an image forming apparatus, and an image forming program, and more particularly relates to a technique of forming an observation image by a chemical reaction of a precursor of an image forming material.

### 2. Description of the Related Art

A mono-sheet-type silver halide photographic photosensitive material for releasing and diffusion transfer of colorants is obtained by incorporating a silver halide photosensitive material, a treatment liquid, and a colorant receiving layer in one film unit. Thus, in a case where an image is captured and the image is processed by a general user, an observation image can be formed. In the silver halide photographic photosensitive material, it is preferable that a time until an image is completed after image processing is shorter. Particularly, there is a strong desire to see an image quickly even in a case where the image is captured and processed at a low temperature. In this respect, improvement is further desired.

In order to solve the problem, a system using a silver halide photographic photosensitive material has been designed based on a policy for transferring each colorant at a high speed (for example, JP2000-112096A and JP2006-113291A).

### SUMMARY OF THE INVENTION

An object of the present invention is to provide an image forming method capable of obtaining an effect of a change of an observation image by intentionally providing an interval between image appearance recognition timings for each region of the observation image, in a case where the observation image appears as an image by a chemical reaction of a precursor of an image forming material such as a mono-sheet-type silver halide photographic photosensitive material for releasing and diffusion transfer of colorants.

In the image forming method in the related art that requires speed for formation of a final image, the problem has not been recognized. That is, in the present invention, a desired effect can be obtained by intentionally setting an image appearance recognition timing to be lower in some regions of the observation image, and the effect cannot be easily obtained from the technique in the related art.

The present invention has been made in view of such circumstances, and an object of the present invention is to provide an image forming method, an image forming apparatus, and an image forming program capable of giving a temporal change to the observation image by intentionally providing a time difference between image appearance recognition timings for a plurality of regions of the observation image.

In order to achieve the above object, according to a first aspect of the present invention, there is provided an image forming method of forming an observation image by drawing and forming an image pattern on a support using a precursor of an image forming material and causing a chemical reaction to progress on the precursor, the observation image including at least one or more regions of a first image region and a second image region having different image appearance recognition timings, the method including: a step of acquiring one or a plurality of original images and determining, from the acquired original images, a first image and a second image respectively corresponding to the first image region and the second image region; a step of creating a first drawing condition for the first image, the first drawing condition satisfying a condition of the image appearance recognition timing of the first image region; a step of creating a second drawing condition for the second image, the second drawing condition satisfying a condition of the image appearance recognition timing of the second image region; and a step of generating an input image which is to be used for forming the observation image based on the first image, the first drawing condition, the second image, and the second drawing condition.

According to the first aspect of the present invention, it is possible to generate an input image which is to be used for forming an observation image by applying the first drawing condition to the first image and applying the second drawing condition to the second image.

According to a second aspect of the present invention, in the image forming method, the image pattern is drawn and formed based on the input image using the precursor, and the observation image including the first image region and the second image region having different image appearance recognition timings is formed. In the observation image formed in this way, it is possible to intentionally provide a time difference between the image appearance recognition timing of the first image region and the image appearance recognition timing of the second image region in the observation image.

According to a third aspect of the present invention, in the image forming method, preferably, the image appearance recognition timing represents a timing when a highest density portion of the image region appears to be recognizable after a start of the chemical reaction, and a difference between the image appearance recognition timing of the first image region and the image appearance recognition timing of the second image region is equal to or longer than 5 seconds and equal to or shorter than 12 hours.

According to a fourth aspect of the present invention, in the image forming method, preferably, the observation image is formed by inputting the input image to a mono-sheet-type silver halide photographic photosensitive material for releasing and diffusion transfer of colorants and performing development processing.

According to a fifth aspect of the present invention, in the image forming method, preferably, the mono-sheet-type silver halide photographic photosensitive material for releasing and diffusion transfer of colorants includes at least a plurality of silver halide emulsion layers having different color sensitivities and a plurality of colorant releasing layers corresponding to each of the silver halide emulsion layers, a colorant released by development processing is immobilized in a colorant receiving layer, and the observation image is formed, and an amount of a colorant per unit area that is released from a colorant layer closest to the colorant receiving layer in a highest density portion of the first image region is greater than an amount of a colorant per unit area that is released from the colorant layer in a highest density portion of the second image region.

According to a sixth aspect of the present invention, in the image forming method, preferably, assuming that, after the development processing is started, a timing when at least one of densities of three primary colors of a highest density portion of the first image region is equal to or higher than 0.04 is T1, and a timing when at least one of densities of three primary colors of the highest density portion of the first image region is equal to or higher than 0.08 is T2, the first image region is a region which satisfies the following Equation and in which a highest density among the densities of three primary colors of the highest density portion of the first image region after 24 hours from the start of the development processing is equal to or higher than 0.40 and lower than 3.0,

1 second≤T2−T1≤15 seconds,
and assuming that, after the development processing is started, a timing when at least one of densities of three primary colors of a highest density portion of the second image region is equal to or higher than 0.04 is T3, the second image region is a region which satisfies the following Equation, in which the image appearance recognition timing is later than the image appearance recognition timing of the first image region, and in which a highest density among the densities of three primary colors of the highest density portion of the second image region after 24 hours from the start of the development processing is equal to or higher than 0.08 and lower than 2.5,

5 seconds≤T3−T2≤12 hours.

According to a seventh aspect of the present invention, in the image forming method, preferably, a total ΣDa of density values of three primary colors of a highest density portion of the first image region after 24 hours from the start of the development processing satisfies the following Equation,

0.50≤ΣDa≤8.0,
a total ΣDb of density values of three primary colors of a highest density portion of the second image region after 24 hours from the start of the development processing satisfies the following Equation,

0.20≤ΣDb≤3.5,
and a difference between the total ΣDa and the total ΣDb satisfies the following Equation,

0.50≤ΣDa−ΣDb≤7.8.

According to an eighth aspect of the present invention, in the image forming method, preferably, an L* value of a highest density portion of the first image region in a CIE LAB color space is equal to or larger than 5 and equal to or smaller than 70, an L* value of a highest density portion of the second image region in a CIE LAB color space is equal to or larger than 60 and equal to or smaller than 95, and a difference between the L* value of the first image region and the L* value of the second image region is equal to or larger than 15 and equal to or smaller than 80.

According to a ninth aspect of the present invention, in the image forming method, a hue angle h of a highest density portion of the first image region is in any one range of 0° or more and 75° or less, 95° or more and 215° or less, or 235° or more and 340° or less, a hue angle h of a highest density portion of the second image region is in any one range of 0° or more and 120° or less, 135° or more and 235° or less, or 330° or more and 360° or less, and the hue angle h is an angle represented by h=arctan (b*/a*) in a CIE LAB color space.

According to a tenth aspect of the present invention, in the image forming method, preferably, the observation image is an image obtained by diffusing and transferring a solid-dispersed anionic colorant into a colorant receiving layer by a treatment using an alkaline liquid and immobilizing the anionic colorant in the colorant receiving layer, the observation image being drawn using the anionic colorant in a plurality of layer regions having different distances from the colorant receiving layer, in the step of creating the first drawing condition and the second drawing condition, a drawing condition for drawing the observation image using the anionic colorant in the plurality of layer regions having different distances from the colorant receiving layer is created, the chemical reaction is a treatment using the alkaline liquid, and an amount of a colorant per unit area that is released from a solid-dispersed-colorant-containing layer closest to the colorant receiving layer in a highest density portion of the first image region is greater than an amount of a colorant per unit area that is released from the solid-dispersed-colorant-containing layer in a highest density portion of the second image region.

According to an eleventh aspect of the present invention, in the image forming method, preferably, the observation image is formed as a colored colorant image by drawing, on the support, the image pattern using an ink composition containing an oxidative coloring colorant and a reducing agent which is oxidized by oxygen and oxidizing the reducing agent and the colorant by oxygen in an atmosphere, in the step of creating the first drawing condition and the second drawing condition, compositions of the ink composition and drawing conditions are created, the chemical reaction is oxidation by oxygen in the atmosphere, and drawing is performed such that the first image region has a reducing activity lower than a reducing activity of the second image region.

According to a twelfth aspect of the present invention, in the image forming method, preferably, the observation image is formed as an image of metallic silver fine particles by reducing an image, which is drawn on the support using an ink composition containing silver ions, by a reducing agent, in the step of creating the first drawing condition and the second drawing condition, compositions of the ink composition for imparting a reducing activity and drawing conditions are created, the chemical reaction is reduction, and drawing is performed such that the first image region has a reducing activity higher than a reducing activity of the second image region.

According to a thirteenth aspect of the present invention, there is provided an image forming method of forming an observation image by drawing and forming an image pattern on a support using a precursor of an image forming material and causing a chemical reaction to progress on the precursor, the observation image including at least one or more regions of a first image region and a second image region having different image appearance recognition timings, the method including: a step of determining a plurality of regions of a subject, the plurality of regions including a first region and a second region respectively corresponding to the first image region and the second image region; a step of preparing a first capturing environment for the first region, the first capturing environment satisfying a condition of the image appearance recognition timing of the first image region; a step of preparing a second capturing environment for the second region, the second capturing environment satisfying a condition of the image appearance recognition timing of the second image region; and a step of generating an input image which is to be used for forming the observation image by capturing the subject under the first capturing environment and the second capturing environment.

According to the thirteenth aspect of the present invention, it is possible to generate an input image which is to be used for forming an observation image by preparing, as a first capturing environment and a second capturing environment, capturing environments for the first image region and the second image region included in the subject and capturing the subject under the first capturing environment and the second capturing environment.

According to a fourteenth aspect of the present invention, in the image forming method, preferably, at least one of the first region and the second region is a region in which a display exists, and in at least one of the step of preparing the first capturing environment and the step of preparing the second capturing environment, an image to be displayed on the display is adjusted.

According to a fifteenth aspect of the present invention, in the image forming method, the image pattern is drawn and formed based on the input image using the precursor, and the observation image including the first image region and the second image region having different image appearance recognition timings is formed.

According to a sixteenth aspect of the present invention, in the image forming method, preferably, the image appearance recognition timing represents a timing when a highest density portion of the image region appears to be recognizable after a start of the chemical reaction, and a difference between the image appearance recognition timing of the first image region and the image appearance recognition timing of the second image region is equal to or longer than 5 seconds and equal to or shorter than 12 hours.

According to a seventeenth aspect of the present invention, in the image forming method, preferably, the observation image is formed by inputting the input image to a mono-sheet-type silver halide photographic photosensitive material for releasing and diffusion transfer of colorants and performing development processing.

According to an eighteenth aspect of the present invention, there is provided an image forming apparatus that causes a processor to generate an input image which is to be used for forming an observation image from original images, the observation image being obtained by drawing and forming an image pattern on a support using a precursor of an image forming material and causing a chemical reaction of the precursor to progress for image appearance and includes at least one or more regions of a first image region and a second image region having different image appearance recognition timings, in which the processor is configured to perform processing of acquiring one or a plurality of the original images, processing of determining, from the acquired original images, a first image and a second image respectively corresponding to the first image region and the second image region, processing of creating a first drawing condition for the first image, the first drawing condition satisfying a condition of the image appearance recognition timing of the first image region, processing of creating a second drawing condition for the second image, the second drawing condition satisfying a condition of the image appearance recognition timing of the second image region, and processing of generating the input image based on the first image, the first drawing condition, the second image, and the second drawing condition.

According to the eighteenth aspect of the present invention, it is possible to generate an input image which is to be used for forming an observation image by applying the first drawing condition to the first image and applying the second drawing condition to the second image.

According to a nineteenth aspect of the present invention, in the image forming apparatus, preferably, the image appearance recognition timing represents a timing when a highest density portion of the image region appears to be recognizable after a start of the chemical reaction, and a difference between the image appearance recognition timing of the first image region and the image appearance recognition timing of the second image region is equal to or longer than 5 seconds and equal to or shorter than 12 hours.

According to a twentieth aspect of the present invention, there is provided an image forming program that causes a computer to realize a method of generating an input image which is to be used for forming an observation image, the observation image being obtained by drawing and forming an image pattern on a support using a precursor of an image forming material and causing a chemical reaction of the precursor to progress for image appearance and includes at least one or more regions of a first image region and a second image region having different image appearance recognition timings, in which the method of generating the input image includes a step of acquiring one or a plurality of original images and determining, from the acquired original images, a first image and a second image respectively corresponding to the first image region and the second image region, a step of creating a first drawing condition for the first image, the first drawing condition satisfying a condition of the image appearance recognition timing of the first image region, a step of creating a second drawing condition for the second image, the second drawing condition satisfying a condition of the image appearance recognition timing of the second image region, and a step of generating an input image which is to be used for forming the observation image based on the first image, the first drawing condition, the second image, and the second drawing condition.

According to the present invention, it is possible to intentionally provide a time difference in the image appearance recognition timings between a plurality of regions of the observation image. Therefore, it is possible to change images that appear in a process of forming the observation image like an animation.

### BRIEF DESCRIPTION OF THE DRAWINGS

FIG. 1 is a graph illustrating an example of a relationship between a time after a start of development processing and densities of an image A of a first image region and an image B of a second image region, the images being appeared as observation images.

FIG. 2 is a conceptual diagram illustrating an observation image according to Example 1.

FIG. 3 is a conceptual diagram illustrating an observation image according to Example 2.

FIG. 4 is a chart illustrating characteristics of a plurality of observation image samples corresponding to the observation image according to Example 1.

FIG. 5 is a chart illustrating characteristics of a plurality of observation image samples corresponding to the observation image according to Example 2.

FIG. 6 is a chart illustrating characteristics of a plurality of observation image samples corresponding to the observation image according to Example 3.

FIG. 7 is a diagram illustrating an appearance of a smartphone as an embodiment of an image forming apparatus according to the present invention.

FIG. 8 is a block diagram illustrating an internal configuration of the smartphone illustrated in FIG. 7.

### DESCRIPTION OF THE PREFERRED EMBODIMENTS

Hereinafter, preferred embodiments of an image forming method, an image forming apparatus, and an image forming program according to an aspect of the present invention will be described with reference to the accompanying drawings.

### Definition of Methods and Terms

Prior to description of the present embodiment, methods and terms used in this specification will be described.

### Image Forming Method

An observation image according to the present invention is formed as an image which can be visually observed by drawing and forming, on a support, an image pattern using a precursor of an image forming material and causing a chemical reaction to progress on the precursor.

One aspect of a method of forming an observation image is a method of forming an image by making a colorant or a precursor of the colorant, which is in an immobilized state and exists at a position which cannot be observed from the outside, into a diffusible state by using a chemical reaction, and diffusing the colorant or the precursor of the colorant to a position which can be observed.

As a specific example, there is a method of forming an image by making a colorant, which is in an immobilized state and exists in a layer that is on a rear surface of a white pigment layer and cannot be observed from the outside, into a state where the colorant can be selectively diffused according to an exposed image by using a reduction reaction of a silver halide emulsion exposed in an image pattern, and diffusing the colorant to a position which is on a front surface side of the white pigment layer and can be observed.

As another specific example, in order to diffuse the colorant from a rear surface side of the white pigment layer to the front surface side of the white pigment layer as described above, a method of drawing an image pattern in advance using the colorant, solubilizing the colorant with an alkaline liquid, and diffusing the colorant may be adopted.

Another aspect of the method of forming an observation image is a method of obtaining a coloring material by chemically reacting a precursor of an image forming material having a coloring level which is not recognized as a real image and converting the coloring material into an image which can be visually observed by a person.

As a specific example, there is a method of drawing, on a support, an image pattern by using a leuco colorant, which has a property of being colored when oxidized and is substantially colorless in a reduction state, and forming an image by oxidizing the leuco colorant and coloring the image pattern.

### Method of Drawing and Forming Image Pattern

In the present invention, the “method of drawing and forming an image pattern” is roughly classified into three methods.

In one aspect, there is a method of drawing a shape according to a pattern which is observed after a chemical reaction by using a direct precursor of an image forming material (substance) itself.

In another aspect, there is a method of drawing an image pattern by using a chemical substance for inducing a chemical reaction in a system such that an image forming substance causes a desired chemical reaction in the image pattern, for example, a method of drawing an image pattern by using a reducing agent, rather than a method of drawing an image pattern by using a direct precursor of an image forming substance itself.

In still another aspect, there is a method of inputting a trigger for starting of a chemical reaction of an image pattern into another chemical substance in a system such that an image forming substance causes a desired chemical reaction in the image pattern, for example, a method of exposing a silver halide emulsion, rather than a method of drawing an image pattern by using a direct precursor of an image forming substance itself.

In drawing of an image pattern, in a case where an ink composition is used, known techniques for coating and printing may be used. Preferably, for drawing of a fine image, an ink jet method is used. In drawing of an image pattern by using a silver halide photographic material, drawing may be performed using a known exposure method.

### Chemical Reaction

In the present invention, the “chemical reaction” includes oxidation and reduction of a precursor of a colorant, a chromophore formation reaction, coloring by reduction of metal ions, and release of a colorant in an immobilized state, from a viewpoint of easy control of a reaction. In particular, in a case of causing a chemical reaction to progress, preferably, the chemical reaction includes an irreversible change of a material such as consumption of a reducing agent or an oxidizing agent.

The start of the chemical reaction refers to a timing when supplying of a precursor of an image forming substance and a component required for the chemical reaction onto a support is started. For example, in a case of development, the start of the chemical reaction refers to a timing when a developer comes into contact with a photosensitive material, and in a case of oxidation by air, the start of the chemical reaction refers to a timing when all required components are applied on a support and are exposed to air.

### Image Appearance Recognition Timing

The observation image appears as an image which can be visually observed by causing a chemical reaction to progress on the precursor. Here, a timing when the image appears to be recognizable (hereinafter, referred to as “image appearance recognition timing”) refers to a timing when, in a process in which a chemical reaction on an observation material is started and a density of the image increases, a highest density portion of the image at the timing can be recognized by an observer.

A limitation on the image density (=log₁₀ (incident light intensity/reflected light intensity)) at which the appearance of the image can be recognized differs depending on a background density of the support on which the image is formed and a fluctuation of the support. For example, in a case of Japanese paper having a very-low reflectance and a slight fluctuation or a support having a fine fabric pattern, it is difficult to recognize the appearance of the image. Further, an area of a high density region is likely to be recognized as a region in which image regions having a diameter of 1 mmφ or more or regions having a width of 0.3 mm or more are linearly connected to each other. In describing recognition of an appearance of an image using a numerical value, in a case of a support having a small fluctuation in reflectance, that is, a high uniformity in reflectance, in a state where a density difference between the image and a surrounding directly adjacent to the image is equal to or larger than 0.04, preferably, equal to or larger than 0.06, many people can recognize an appearance of the image.

A temperature at which an observer observes the appearance of the image is not particularly limited, and is, for example, a room temperature of −10° C. to 50° C., preferably 0° C. to 40° C., and more preferably 10° C. to 30° C.

### Mono-Sheet-Type Silver Halide Photographic Photosensitive Material for Releasing and Diffusion Transfer of Colorants

A mono-sheet-type silver halide photographic photosensitive material for releasing and diffusion transfer of colorants includes a material containing an alkaline-treated composition that is provided between a photosensitive sheet and a transparent cover sheet. Components of the material include, for example, an alkaline material, a development agent, a light-shielding material, a viscosity improver, a transparent support, an image receiving layer, a white reflective layer, a colorant image forming compound, a silver halide emulsion, a color-mixing inhibitor, a high-boiling-point organic solvent, a layer having a neutralizing function, a surfactant, a polymer latex, and the like, and components described in JP2000-112096A and JP2006-113291A may be used.

Preferably, the silver halide photographic photosensitive material includes a multi-layered silver halide emulsion layer having different color sensitivities. Preferably, the silver halide photographic photosensitive material is a photosensitive material that is sensitive to three colors (three primary colors of light) of R (red), G (green), and B (blue) and reproduces colors by a subtractive color method using colorants of three colors (three primary colors) of Y (yellow), M (magenta), and C (cyan). For example, techniques described in JP2000-112096A and JP2006-113291A may be used. Further, a photosensitive material of a film for “checking” (instant film, instax mini (trade name)) including some of the technical contents may be used.

### First Embodiment of Image Forming Method

The following description may be realized based on a representative embodiment of the present invention. On the other hand, the present invention is not limited to such an embodiment. Further, in the present invention and this specification, the numerical range represented by using “to” means a range including numerical values “to”, both ends inclusive, as a lower limit value and an upper limit value.

In the first embodiment of the image forming method according to the present invention, a mono-sheet-type silver halide photographic photosensitive material for releasing and diffusion transfer of colorants is used.

An observation image is formed by (optically) inputting an input image generated by the following steps to the mono-sheet-type silver halide photographic photosensitive material for releasing and diffusion transfer of colorants and performing development processing. That is, by inputting an input image to the mono-sheet-type silver halide photographic photosensitive material for releasing and diffusion transfer of colorants, an image pattern is drawn and formed using a precursor of an image forming material. Further, development processing corresponds to a chemical reaction.

The observation image obtained by the image formation includes at least one image region of a first image region or a second image region having different image appearance recognition timings. In this example, the first image region of the observation image is an image region in which the image appearance after the start of development processing is relatively earlier than the image appearance in the second image region.

The input image, which is used for forming the observation image including the first image region and the second image region having the above-described characteristics, is generated by the following steps.

(1) One or a plurality of original images are acquired. From the acquired original images, a first image and a second image respectively corresponding to the first image region and the second image region are determined (step (1)).

(2) A first drawing condition for the first image is created, the first drawing condition satisfying a condition of the image appearance recognition timing of the first image region (step (2)).

(3) A second drawing condition for the second image is created, the second drawing condition satisfying a condition of the image appearance recognition timing of the second image region (step (3)).

(4) An input image which is to be used for forming an observation image is generated based on the first image, the first drawing condition, the second image, and the second drawing condition (step (4)).

Here, the image appearance recognition timing represents a timing when a chemical reaction is started and then a highest density portion of the image region appears to be recognizable. Preferably, a difference between the image appearance recognition timing of the first image region and the image appearance recognition timing of the second image region is equal to or longer than 5 seconds and equal to or shorter than 12 hours.

Specifically, the image appearance recognition timing represents a timing when development processing is started as a start of a chemical reaction and then, in a highest density portion of the observation image, at least one of densities of the three colors (three primary colors of light) of blue (B), green (G), and red (R) exceeds 0.04. In the present invention, the densities of B, G, and R represent densities measured under a filter condition of status A in a state where a D65 light source is used.

Further, assuming that, after development processing is started, a timing when at least one of densities of B, G, and R of the highest density portion of the first image region is equal to or higher than 0.04 is T1 and that a timing when at least one of densities of B, G, and R of the highest density portion of the first image region is equal to or higher than 0.08 is T2, the first image region satisfies the following Equation.

1 second≤T2−T1≤15 seconds

Further, the first image region is a region in which a highest density among the densities of B, G, and R of the highest density portion of the first image region after 24 hours from the start of development processing is equal to or higher than 0.40 and lower than 3.0.

The image appearance recognition timing T1 of the first image region is not particularly limited, and is, for example, a timing of 5 seconds to 90 seconds, preferably 10 seconds to 80 seconds, and more preferably 10 seconds to 70 seconds. At the timing T1 when the image density is 0.04, an appearance of the image can be recognized. On the other hand, it is somewhat difficult to instantly understand the contents of the image. At the timing T2 when the image density is 0.08, the density is increased, and a time is elapsed from the timing T1. Thus, the contents of the image can be sufficiently recognized.

A difference (T2−T1) between the image appearance recognition timings T1 and T2 is not limited to the range represented by the above Equation, and is preferably 2 seconds to 12 seconds, more preferably 2 seconds to 8 seconds.

On the other hand, the second image region is an image region in which the image appearance recognition timing is later than the image appearance recognition timing of the first image region. Assuming that, after development processing is started, a timing when at least one of densities of B, G, and R of the highest density portion of the second image region is equal to or higher than 0.04 is T3, the second image region satisfies the following Equation.

5 seconds≤T3−T2≤12 hours

Further, the second image region is a region in which a highest density among the densities of B, G, and R of the highest density portion of the second image region after 24 hours from the start of development processing is equal to or higher than 0.08 and lower than 2.5.

A difference (T3−T2) between the image appearance recognition timings T2 and T3 is not limited to the range represented by the above Equation, and is preferably 5 seconds to 30 minutes, more preferably 6 seconds to 20 minutes.

As described above, in the observation image, the image of the first image region and the image of the second image region respectively satisfy the ranges represented by the above Equations. Therefore, a sufficient and appropriate time interval can be obtained from the recognition of the image (image A) of the first image region to the recognition of the image (image B) of the second image region.

The present inventors found that, in the silver halide photographic photosensitive material for releasing and diffusion transfer of colorants, the image recognition timing is not always the same depending on a combination of colorants of each color and a density region of each color. On the contrary, the present inventors considered that, in a case where a final observation image is created based on characteristics of the photosensitive material for releasing and diffusion transfer of colorants and visual characteristics of a person who performs observation, it is possible to make a significant difference in the image appearance recognition timing for each image. For example, the present inventors considered that it is possible to obtain an effect such as animation by making each image of a plurality of regions of the observation image appear at time intervals and making messages according to each image appear in order.

The effect such as animation includes an effect in which each image of a first image region and a second image region is recognized as a first frame as in a two-frame cartoon and then a second frame is recognized for the first time, an effect in which a specific object is gradually focused on the same screen, an effect in which information of a first image is erased by information of a second image with a lapse of time.

In the first embodiment, unless otherwise specified, the timings T1, T2, and T3 related to the image appearance represent values obtained by performing exposure, development processing, and observation of the silver halide photographic photosensitive material at 25° C. Further, in the first embodiment, the observation image is an image formed by immobilizing a transfer colorant in a colorant receiving layer on the mono-sheet-type silver halide photographic photosensitive material for releasing and diffusion transfer of colorants.

In a case of determining the image appearance recognition timing, a minimum density at that timing is set to Dmin, and the densities of B, G, and R are determined based on a difference between a density of an image and the minimum density Dmin. The minimum density represents a density of a portion of the photosensitive material that is not intentionally colored with a colorant on an observation image plane. The reason is as follows. A treatment liquid permeates into the photosensitive material in a process of development processing and then is subjected to a process such as drying. As a result, a reflection and scattering condition changes with time, and thus the minimum density of the observation image changes according to a time after the start of development processing.

### Recognition Timing Related to Image Appearance

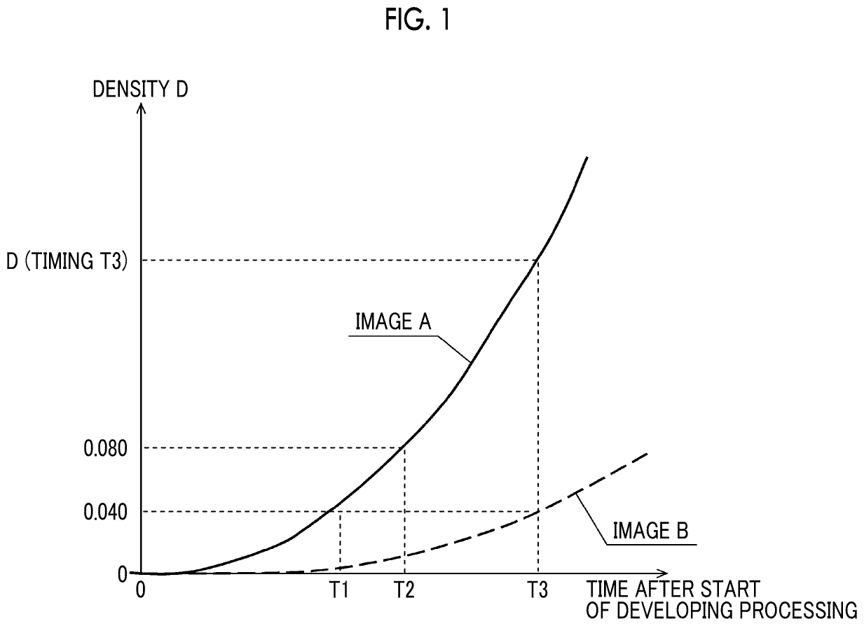

FIG. 1 is a graph illustrating an example of a relationship between a time after the start of development processing and densities of an image A of the first image region and an image B of the second image region, the images being appeared as observation images.

In FIG. 1, in the density of the image A of the first image region that is indicated by a solid line graph, at the timing T1 after development processing, at least one of the densities of B, G, and R of the highest density portion of the first image region reaches 0.04. On the other hand, in the density of the image B of the second image region that is indicated by a broken line graph, at the timing T3 after development processing, at least one of the densities of B, G, and R of the highest density portion of the second image region reaches 0.04.

Further, in the density of the image A of the first image region that is indicated by the solid line graph, at the timing T2 after development processing, at least one of the densities of B, G, and R of the highest density portion of the first image region reaches 0.08.

Here, regarding to the image density of the first image region, at the timing T1 when the image density is 0.04, an appearance of the image A can be recognized. On the other hand, it is somewhat difficult to instantly understand the contents of the image A. At the timing T2 when the image density is 0.08, the density is increased, and a time is elapsed from the timing T1. Thus, the contents of the image A can be sufficiently recognized.

Further, the difference (T3−T2) between the image appearance recognition timings T2 and T3 from the image appearance recognition timing T2 to the image appearance recognition timing T3 satisfies the range represented by the above Equation. Therefore, a sufficient and appropriate time interval can be obtained from the recognition of the image A of the first image region to the recognition of the image B of the second image region.

In a case where the image appearance in the second image region takes 12 hours, which is a maximum value of the range represented by the above Equation, for example, in a case where there is a relationship such as “question” and “answer” between the image A of the first image region and the image B of the second image region, it means that a time of approximately overnight is allowed for thinking “answer”.

At the image appearance recognition timing T3 of the second image region, at least one density D (at the timing T3) of the densities of B, G, and R of the highest density portion of the first image region is preferably 0.15 to 3.0, more preferably 0.25 to 2.60, and most preferably 0.30 to 2.40. At the timing T3 when the image appearance in the second image region is recognized, there is a sufficient difference in density between the image A of the first image region and the image B of the second image region. Thus, the image A of the first image region can be clearly and strongly recognized. In the present embodiment, a moment when the treatment liquid comes into contact with a film surface of the photosensitive material is set as a starting point of a start timing of development processing.

Further, regarding to the image appearance recognition timing, it is necessary that the observation image is divided into at least two stages, the first image region in which the image appearance recognition timing is relatively earlier and the second image region in which the image appearance recognition timing is relatively later. On the other hand, in the second image region, there may be a region in which the image appearance recognition timing is further later. In such a case, an appearance of each image of which the image appearance recognition timing is different may be set in three stages or more.

The first image region may include a plurality of image regions in which the image appearance recognition timings are substantially the same.

Similarly, the second image region may also include a plurality of image regions in which the image appearance recognition timings are substantially the same.

### Control of Image Appearance Recognition Timing

According to one aspect of the present invention, considering a spectral sensitivity distribution of human eyes when the observer recognizes an image, as the image A of the first image region, preferably, an image which has a hue in which the density of G and the density of R are high and has high visibility is used. On the contrary, as a hue of the image B of the second image region, preferably, a hue in which the density of G and the density of R are low and the density of B is high is used.

Further, the image A of the first image region needs to be early recognized as a colorant image, and in order to increase an amount of a colorant to be diffused, it is effective to increase a density gradient of the colorant in the photosensitive material. Therefore, it is preferable to increase an amount of a colorant to be produced.

In the present embodiment, one preferred embodiment for changing the image appearance recognition timings of the first image region and the second image region will be described.

Specifically, a total ΣDa of density values of the three primary colors (density values of R, G, and B) of the highest density portion of the first image region after 24 hours from the start of development processing of the observation image satisfies the following Equation.

0.50Σ≥Da≤8.0

Further, a total ΣDb of density values of the three primary colors (density values of R, G, and B) of the highest density portion of the second image region after 24 hours from the start of the development processing satisfies the following Equation.

0.20≤ΣDb≤3.5

Preferably, the image density is set such that a difference between the total ΣDa and the total ΣDb satisfies the following equation.

0.50≤ΣDa−ΣDb≤7.8.

Here, as shown in the above Equation, ΣDa is preferably 0.50 to 8.0, more preferably 0.80 to 8.0, and most preferably 1.2 to 7.00. ΣDa is set within the range, and thus the image appearance recognition timing of the first image region can be preferably set to a desired earlier timing.

Further, as shown in the above Equation, ΣDb is preferably 0.20 to 3.50, more preferably 0.60 to 3.0, and most preferably 0.70 to 2.8. ΣDb is set within the range, and thus, finally, the density of the image B of the second image region after 24 hours also is a sufficient density to some extent. Therefore, the image appearance recognition timing T3 can be preferably delayed by a certain value or more.

Further, as shown in the above Equation, ΣDa-ΣDb is preferably 0.50 to 7.80, more preferably 0.70 to 6.5, and most preferably 1.00 to 5.50. ΣDa−ΣDb is set within the range, and thus T3−T2 can fall within a certain range. Therefore, a difference in the image appearance recognition timing between the image A of the first image region and the image B of the second image region can be significantly felt.

Further, an impression when the observer recognizes the observation image as an image is greatly affected by brightness of the image. Thus, in the observation image after 24 hours from the start of development processing, preferably, in a CIE LAB color space, an L* value of the highest density portion of the image A of the first image region is equal to or larger than 5 and equal to or smaller than 70, an L* value of the highest density portion of the image B of the second image region is equal to or larger than 60 and equal to or smaller than 95, and a difference between the L* value of the image A of the first image region and the L* value of the image B of the second image region (ΔL* value=L* value of the image B−L* value of the image A) is equal to or larger than 15 and equal to or smaller than 80.

Here, ΔL* value is more preferably 20 to 80, and most preferably 30 to 75. In a state where the condition of the ΔL* value is satisfied, the L* value of the highest density portion of the image A is preferably 5 to 70, more preferably 5 to 60, and most preferably 5 to 55. Further, the L* value of the highest density portion of the image B is preferably 60 to 95, more preferably 70 to 90, and most preferably 75 to 85.

The L* value is set within the range, and thus it becomes easy to clearly designate the difference in the image appearance recognition timings of the image A and the image B. Therefore, after the appearance of the image A, the density of the image B can be visually recognized.

In the present embodiment, a chromaticity value represents a value in a CIE 1976 L*a*b* color space (hereinafter, abbreviated as “CIE LAB color space”). Details of the CIE LAB color space are described in “Fine Imaging and Color Hard Copy” edited by Japanese Society of Photography and Japanese Society of Imaging, on page 354 (1999, published by Corona Publishing Co., Ltd.). In the present embodiment, the chromaticity value represents a chromaticity value of the observation image itself without subtraction of a white background of the photographic photosensitive material.

Further, in the present embodiment, in the observation image after 24 hours from the start of development processing, after the condition of the L* value is satisfied, preferably, hue angles of the highest density portions of the image A and the image B satisfy the following conditions.

Specifically, preferably, the hue angle h of the highest density portion of the image A of the first image region is in any one range of 0° or more and 75° or less, 95° or more and 215° or less, or 235° or more and 340° or less, and the hue angle h of the highest density portion of the image B of the second image region is in any one range of 0° or more and 120° or less, 135° or more and 235° or less, or 330° or more and 360° or less.

Here, the hue angle h is an angle represented by h=arctan (b*/a*) in the CIE LAB color space.

In a case of explaining the range using a schematic image, the image A has a hue of red, green, or blue. In the photosensitive material that reproduces colors by a subtractive color method using colorants of three colors of yellow, magenta, and cyan, a hue in which colorants of two colors, preferably, three colors are mixed is used. Further, the image B has a hue in which magenta and cyan are partially mixed with a monochromatic yellow color as a main color, a hue in which yellow and magenta are mixed with a monochromatic cyan color as a main color, or a monochromatic magenta color. By using such a combination of colorants, it is possible to improve visibility of the final image and set a difference in the image appearance recognition timing to be sufficiently large.

### Control of Colorant Releasing Layer

The mono-sheet-type silver halide photographic photosensitive material for releasing and diffusion transfer of colorants to which the present invention is applied includes at least a plurality of silver halide emulsion layers having different color sensitivities and a plurality of colorant releasing layers corresponding to each of the silver halide emulsion layers. A colorant released by development processing is immobilized in the colorant receiving layer, and thus a final observation image is formed.

Preferably, in the observation image, an amount of a colorant per unit area that is released from a colorant layer closest to the colorant receiving layer in the highest density portion of the first image region is greater than an amount of a colorant per unit area that is released from the colorant layer in the highest density portion of the second image region. By adopting this aspect, it is possible to increase the difference in the image appearance recognition timing between the image A of the first image region and the image B of the second image region of the observation image.

In particular, preferably, the input image corresponding to the image A of the first image region of the observation image is an image for mainly releasing the colorant from the colorant releasing layer closest to the colorant receiving layer by development processing, and the input image corresponding to the image B of the second image region of the observation image is an image for mainly releasing the colorant from the colorant releasing layer farthest from the colorant receiving layer by development processing.

Here, in a case where the colorant releasing layer includes three layers of a lowermost layer, a middle layer, and an uppermost layer, as one practical aspect of the color photosensitive material, a configuration in which the lowermost layer is a cyan colorant releasing layer, the middle layer is a magenta colorant releasing layer, and the uppermost layer is a yellow colorant releasing layer may be adopted.

From a viewpoint that visibility is improved as the final image density is higher, in the image A of the first image region, as a layer for supplying colorant which allows the image A to be recognized in a short time after the start of development processing, three layers may be most preferably used, two layers may be more preferably used, or one layer may be preferably used.

Further, from a viewpoint that a diffusion distance of the colorant is short, the colorant may be provided, most preferably in the lowermost layer+the middle layer+the uppermost layer, and preferably in the lowermost layer+the middle layer or in the lowermost layer+the uppermost layer. The colorant may be provided in the middle layer+the uppermost layer, only in the lowermost layer, or only in the middle layer.

Further, in the image B of the second image region in which the image appearance is relatively later, as a layer for supplying a colorant which allows the image B to be recognized, one layer may be most preferably used, two layers may be preferably used, or three layers are not prohibited.

Further, the colorant may be provided most preferably only in the uppermost layer, or preferably in the uppermost layer+the middle layer. The colorant may be provided in the uppermost layer+the lowermost layer, only in the middle layer, or only in the lowermost layer.

On the other hand, in a final image obtained from the colorant released from the lowermost layer, a condition of an optical density of the image A>an optical density of the image B is essentially satisfied.

As one aspect of the mono-sheet-type silver halide photosensitive material for releasing and diffusion transfer of colorants, a silver halide photographic photosensitive material for diffusion transfer of colorants, which has photosensitivity for wavelength regions of three colors of R, G, and B and to which a monochrome observation image is substantially input, is also known. This can be realized, for example, as follows. A silver halide emulsion layer which has photosensitivity for each of wavelength regions of three colors of B, G, and R is independently provided. For each photosensitive layer, colorants of yellow, magenta, and cyan are mixed and released. Thus, a black image can be substantially formed using a mixture of the colorants of the three colors. Further, preferably, a photosensitive material of a film for “checking” (a film dedicated to checking, monochrome (trade name)) including such technical contents may be used.

Even in a case where the monochrome photosensitive material according to the aspect is used, the emulsion layer to be developed can be selected by controlling exposure wavelengths for R, G, and B. Thus, the layer for releasing the colorant can be appropriately set. For example, in an aspect in which the difference in the image appearance recognition timing is significant, the following configuration may be adopted.

As the layer that releases the colorant for forming the image A of the first image region of the observation image, the lowermost layer+the middle layer+the uppermost layer may be most preferably used, and the lowermost layer+the middle layer or only the lowermost layer may be used.

Further, as the layer that releases the colorant for forming the image B of the second image region of the observation image, only the uppermost layer may be most preferably used, and only the middle layer may be used.

### Method of Generating Input Image

In the image forming method according to the first embodiment, an observation image is formed by inputting an input image to the photosensitive material and performing development processing. In a case of digitally exposing the photosensitive material, as a general color management, a color gamut of the original image is mapped with a color gamut that can be reproduced by the photosensitive material, and an exposure condition for formation of an image in the color gamut is determined.

First, as a preferred first aspect, a case where an input image is generated by combining a plurality of original images will be described.

In this case, in step (1), a plurality of original images are acquired. From the acquired original images, a first image and a second image respectively corresponding to the first image region and the second image region are determined.

In a case where an input image is generated using two original images, one original image may be determined as the first image, and the other original image may be determined as the second image.

While assuming the observation image as a final output, the user determines a before-and-after relationship in the image appearance recognition timing based on a before-and-after relationship in distance between subjects in the image and “meaning context” in the image. Thereby, which image of the two original images is used for the first image region or the second image region can be set.

Examples of combinations of “meaning context” include, for example, [question vs answer], [notice vs answer], [title vs details], [early vs late in a flow of time], [upper phrase vs lower phrase of Tanka], [application vs non-application], and the like. On the other hand, the combinations of “meaning context” are not limited thereto.

The original image may be an image obtained by capturing a person or a landscape, and may be an image created using image software, an illustration, an icon, or text information.

In a case of generating an input image from a plurality of original images, a final input image may be generated by combining a plurality of images such as images and text information created by individually adjusting image appearance recognition timings.

In this example, according to an instruction from the user, from a plurality of original images, the first image (first original image) corresponding to the first image region and the second image (second original image) corresponding to the second image region may be determined. On the other hand, a first original image suitable for the image A of the first image region and a second original image suitable for the image B of the second image region may be determined by using artificial intelligence (AI).

As the AI, for example, a model learned by using a convolution neural network (CNN) may be used. In this case, a learned model may be obtained by performing machine learning on CNN using data sets of learning data, which pairs with correct answer data indicating whether the original image is the first original image suitable for the image A of the first image region or the second original image suitable for the image B of the second image region.

Subsequently, an input image is generated by the following steps (2) to (4) using the first original image determined as the first image and the second original image determined as the second image.

In step (2), a first drawing condition for the first image is created, the first drawing condition satisfying a condition of the image appearance recognition timing of the first image region.

In step (2), the first drawing condition for the first image suitable for the image A of the first image region (the first original image determined as the first image) may be created in consideration of a density and a hue of the image and a colorant generation layer of the photosensitive material for diffusion transfer of colorants. In relation to step (3) to be described, it is necessary to create the first drawing condition for setting the image appearance recognition timing to be relatively earlier.

As one method, in order to form the image A of the first image region, preferably, the first drawing condition for the first original image is created, the first original image being an image which has a high density and a large amount of a colorant and has a main color obtained by mixing a cyan color and a magenta color. For example, in the first original image, the image density may be converted to a high level, or the brightness and the hue may be adjusted. Further, as the first original image, preferably, text information having black, blue, and red colors as main colors may be used.

By performing image processing on the first original image according to the first drawing condition created in this way and generating an input image corresponding to the first image region, the image appearance recognition timing of the first image region in the input image is relatively earlier.

In step (3), a second drawing condition for the second image is created, the second drawing condition satisfying a condition of the image appearance recognition timing of the second image region.

In step (3), contrary to step (2), a second drawing condition for the second image (the second original image determined as the second image) is created to set the image appearance recognition timing of the second image region in the input image to be relatively later. The second drawing condition for the second image suitable for the image B of the second image region may be created in consideration of a density, brightness, and a hue of the second image and a colorant generation layer of the photosensitive material for diffusion transfer of colorants. In relation to step (2), preferably, the second drawing condition for the second image is an image condition for forming an image having a yellow color as a main color.

In step (4), an input image which is to be used for forming an observation image is generated based on the first image, the first drawing condition, the second image, and the second drawing condition.

In step (4), a final input image is generated by performing image processing of adjusting the image densities and the hues of the first image (first original image) and the second image (second original image), which are determined in step (1), according to the first drawing condition created in step (2) and the second drawing condition created in step (3), and combining the images after the image processing.

In a case of finally combining the images as one input image, the image of the first image region and the image of the second image region after the image processing may be combined by being arranged side by side or left and right, or the image A of the first image region such as text information may be superimposed on the image B of the second image region.

Further, in another aspect, the input image may be formed from a single original image.

In a case of generating an input image from one original image, for example, images of regions respectively corresponding to the first image region and the second image region in the original image are respectively determined as the first image and the second image (step (1)).

For example, in step (1), in a case of determining the first image region and the second image region, as a standard for distinguishing and recognizing each region in one original image as an origin, location information in the original image ([left vs right], [center vs periphery], [top vs bottom], [near view vs distant view], or the like), density and hue information of the original image ([high density vs low density], [blue hue vs yellow hue], or the like), or meaning information of the original image ([near view vs distant view], [person vs background], [text information vs background], or the like) may be used. The information may be obtained by applying a method (AI or the like) of extracting and recognizing a specific region from an image by a known technique.

In order to adjust the image appearance recognition timing of each of the first image and the second image, the first image being an image of a region determined as the first image region in one original image, and the second image being an image of a region determined as the second image region in one original image, the first drawing condition and the second drawing condition are created. On the other hand, the first drawing condition and the second drawing condition may be created by step (2) and step (3) as in the case of the plurality of original images.

That is, the first drawing condition and the second drawing condition may be created by adjusting color space conditions (conditions of the image density and the hue) to satisfy the image appearance recognition timings of the first image region and the second image region.

In step (4), an input image which is to be used for forming an observation image is generated based on the first image, the first drawing condition, the second image, and the second drawing condition. In this case, since the first image and the second image are images corresponding to the first image region and the second image region in the original image, it is not necessary to combine the image A and the image B obtained by performing image processing under the first drawing condition and the second drawing condition.

### Second Embodiment of Image Forming Method

A second embodiment of the image forming method according to the present invention is a method of acquiring an input image by preparing a capturing environment, preparing a subject, and capturing the prepared subject, the input image being substantially formed only from images obtained by capturing the subject.

The second embodiment of the image forming method is similar to the first embodiment in that an observation image is formed by inputting an input image to a mono-sheet-type silver halide photographic photosensitive material for releasing and diffusion transfer of colorants and performing development processing. On the other hand, in the second embodiment, a method of generating the input image is different from the method in the first embodiment.

In the second embodiment, an input image, which is to be used for forming an observation image including the first image region and the second image region, is generated by the following steps.

(11) A plurality of regions of the subject are determined, the plurality of regions including a first region and a second region respectively corresponding to the first image region and the second image region (step 11).

(12) A first capturing environment for the first region is prepared, the first capturing environment satisfying a condition of the image appearance recognition timing of the first image region (step 12).

(13) A second capturing environment for the second region is prepared, the second capturing environment satisfying a condition of the image appearance recognition timing of the second image region (step 13).

(14) An input image which is to be used for forming an observation image is generated by capturing the subject under the first capturing environment and the second capturing environment (step 14).

In step (11), in an observation image which is finally obtained, at least the first image region and the second image region are determined in the image region. A region which is not particularly defined may be determined other than the first image region and the second image region.

In step (11), the plurality of regions of the subject to be captured are determined, the plurality of regions including the first region and the second region respectively corresponding to the first image region and the second image region.

Step (12) and step (13) of the second embodiment are different from step (2) and step (3) of the first embodiment. In the latter, drawing conditions for adjusting the density, the brightness, and the hue of the image are created such that the existing image (original image) has a desired image appearance. On the other hand, in the former, a capturing environment for a subject to be captured is adjusted such that an image of the subject has a desired image appearance.

Specifically, in step (12) and step (13), capturing environments are prepared by adjusting coloring, make-up, and lighting conditions (spectrum, intensity) of the subject itself according to the first region and the second region of the subject.

For example, preferably, a desired image is displayed on the display by being adjusted in density, brightness, and hue, and the desired image is used as a part or a background of the subject (first region or second region of the subject). Further, an image in which the density, the brightness, and the hue are adjusted may be projected on a white wall or a curtain.

In step (14), an input image which is to be used for forming an observation image is generated (acquired) by capturing a subject under the capturing environments prepared by step (11), step (12), and step (13).

In the image forming method according to the second embodiment, the input image may be input to the silver halide photographic photosensitive material using two methods of a digital method and an analog method.

One method is a method of converting a digital image of the input image into an exposure condition according to color management which is set in advance based on characteristics of an exposure system and the photosensitive material and exposing the digital image on the silver halide photographic photosensitive material via an exposure head. In this case, a digital image obtained by capturing a subject using a digital camera, a smartphone camera, or the like is used as an input image as it is.

Another method is a method of capturing a subject as it is through an optical system of a camera using a silver halide photographic photosensitive material and inputting a captured image as an input image.

### Exposure of Photosensitive Material

In one aspect of the present invention, an input image is prepared as a digital image and is exposed as optical information which is to be optically sensed by a photosensitive material.

A preferred exposure method applied to the photographic photosensitive material according to the present invention is a method of performing exposure using an exposure head including a plurality of types of light sources having different wavelengths. For example, exposure may be performed according to a method described in JP1999-344772A (JP-H11-344772A). As the exposure head, preferably, an LED head, an organic electro luminescence (EL) head, or an inorganic EL head may be used, and more preferably, an organic EL head may be used. Further, exposure may be performed in a plane by providing a light emitting surface of the display in close contact with the photosensitive material. In this case, a liquid crystal display, an organic EL display, or an inorganic EL display may be used. Even in a case where the photosensitive material is a positive type or a negative type, an input image can be created according to spectral sensitivity of the photosensitive material.

In another aspect of the present invention, the subject may be captured directly through an optical lens, and the photosensitive material may be exposed using an analog method.

### Input Image

In the present invention, the original image which is to be used for generation of the input image may be a single image such as a person image, a landscape image, a captured image of a spot, an illustration image, an icon image, a text image, or a QR code (registered trademark), or a combination of a plurality of images.

Among the plurality of original images, the first image (first original image) corresponding to the image A of the first image region of the final observation image is image-processed according to the first drawing condition created in step (2), and a part (first part) of the input image corresponding to the first image region is created. Similarly, among the plurality of original images, the second image (second original image) corresponding to the image B of the second image region of the final observation image is image-processed according to the second drawing condition created in step (3), and a part (second part) of the input image corresponding to the second image region is created. The first part and the second part may be set as a template. The template may be used at any time. In a case of creating an input image corresponding to a required observation image, a plurality of templates including the first part and the second part may be combined and used.

In the observation image, as the image A of the first image region and the image B of the second image region, a single image or a plurality of images may be used. At a boundary region between the image A and the image B, the input image can be generated (combined) such that two images of the image A and the image B are connected to each other without discomfort in the final image.

In a case where the photosensitive material has positive photosensitivity, it is preferable in that an input image can be created without positive/negative inversion between the input image and the final observation image.

Further, in a case where the image A of the first image region and the image B of the second image region are determined, in images of regions that are not important in the final observation image, there may be an image in which the image appearance recognition timing does not need to be adjusted.

### Capturing

In the image forming method according to the present invention, the captured image may be used as a part or a whole of the original image. There is no limitation on capturing, and preferably, a digital camera or a camera of a smartphone may be used.

### Development Processing

In the present invention, the photosensitive material is developed. As a development agent that can be used in development processing, typically, an alkaline material, a thickener, a light-shielding agent, a developer, a development accelerator, a development inhibitor, an antioxidant, and the like may be contained. A development temperature is not particularly limited, and is, for example, 0° C. to 40° C., preferably 10° C. to 30° C. In a case of calculating a development time and the image appearance recognition timing of the image, in the present invention, a measured value at 25° C. is used.

The present invention will be described in more detail with reference to Examples, and the present invention is not limited thereto.

### Example 1

An observation image is formed by creating an input image according to the following procedure, inputting the input image to the mono-sheet-type silver halide photographic photosensitive material for releasing and diffusion transfer of colorants, and performing development processing.

As the photosensitive material, the mono-sheet-type silver halide photographic photosensitive material for releasing and diffusion transfer of colorants is made by using a photosensitive element No. 103 described in JP2000-112096A, an alkaline treatment composition (developer) filled in a container that can be broken by pressure, and a cover sheet, according to a method described in JP1995-159931A (JP-H7-159931A). Thereby, the observation image having a length of 6.1 cm and a width of 4.5 cm is obtained.

In the colorant releasing layer of the photosensitive material, there are provided a cyan colorant releasing layer (lower layer), a magenta colorant releasing layer (middle layer), and a yellow colorant releasing layer (upper layer) in order of proximity to the colorant receiving layer.

### Creation of Input Image

The observation image has a theme of fortune-telling. In response to a question as to what is a lucky item, an answer to the question is displayed as an icon image.

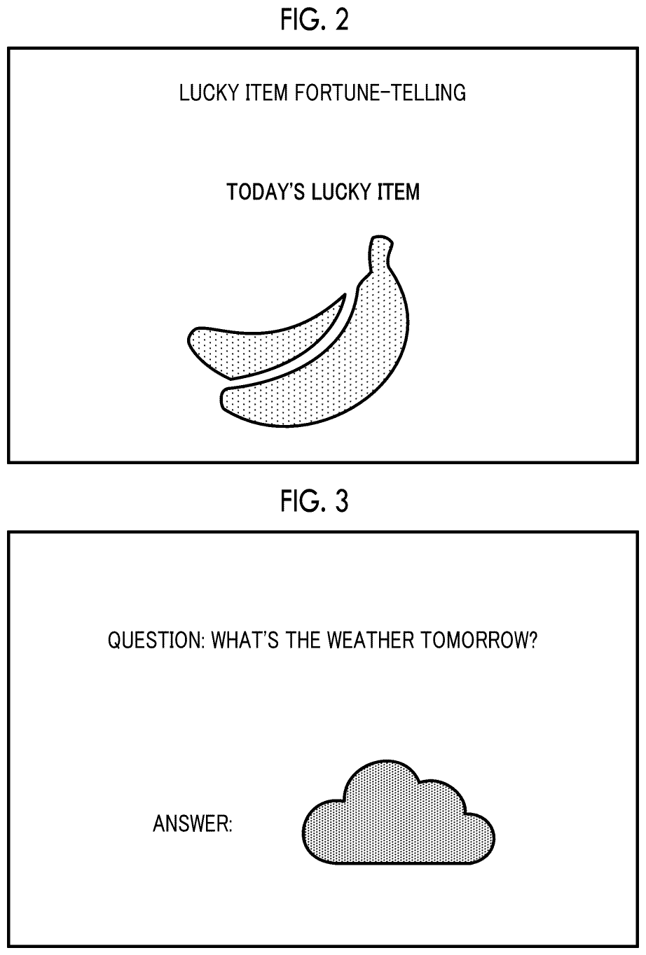

FIG. 2 is a conceptual diagram illustrating an observation image according to Example 1

### First, the Following Steps are Performed as Step (1).

Among a plurality of original images, a text information image of “lucky item fortune-telling” is selected as an image for the image A, and an icon image of “banana” is selected as an image for the image B. Thus, the images which are to be used for the image A and the image B are determined.

Subsequently, the following steps are performed as step (2).

In the image for the image A, for the text information image of “lucky item fortune-telling: what is today's lucky item?”, characteristic values of the density, the brightness, and the hue of the final observation image are set such that conditions of the timings T1 and T2 required for the image appearance of the image A are satisfied. An input image for the photosensitive material is created such that the set final image density is expressed by the photosensitive material.

Specifically, the text information is expressed in bold and slightly dark blue black in MSP Gothic font such that the following conditions are met.
T2−T1 4 seconds
D 1.50 (density of R)
ΣDa 4.40
L* 21
h 270°

Subsequently, the following steps are performed as step (3).

In the image for the image B, for the icon image of “banana”, characteristic values of the density, the brightness, and the hue of the final observation image are set such that a condition of the timing T3 required for the image appearance of the image B is satisfied. An input image for the photosensitive material is created such that the set final image density is expressed by the photosensitive material.

Specifically, the banana icon is expressed in dark yellow having a certain density such that the following conditions are met.
T3−T1 13 seconds
D 1.00 (density of B)
ΣDa 1.47
L* 77
h 90

Subsequently, the following steps are performed as step (4).

An input image for the photosensitive material is created by arranging and combining the image obtained in step (2) and the image obtained in step (3) such that the images have appropriate sizes and a positional relationship on the observation image screen.

### Formation of Observation Image Sample 101 Using Photosensitive Material

The input image obtained in this way is input to the mono-sheet-type silver halide photographic photosensitive material for releasing and diffusion transfer of colorants by using a multi light-emitting head in which light emitting diodes of three colors of R, G, and B are arranged in a main scanning direction according to a method described in JP1999-344772A (JP-H11-344772A).

The developer is applied at 25° C. and with a thickness of 62 μm, and development processing is performed. The input image information is converted into colorant image information, and thus an observation image sample 101 is formed.

### Formation of Observation Image Samples 102 to 109 Using Photosensitive Material

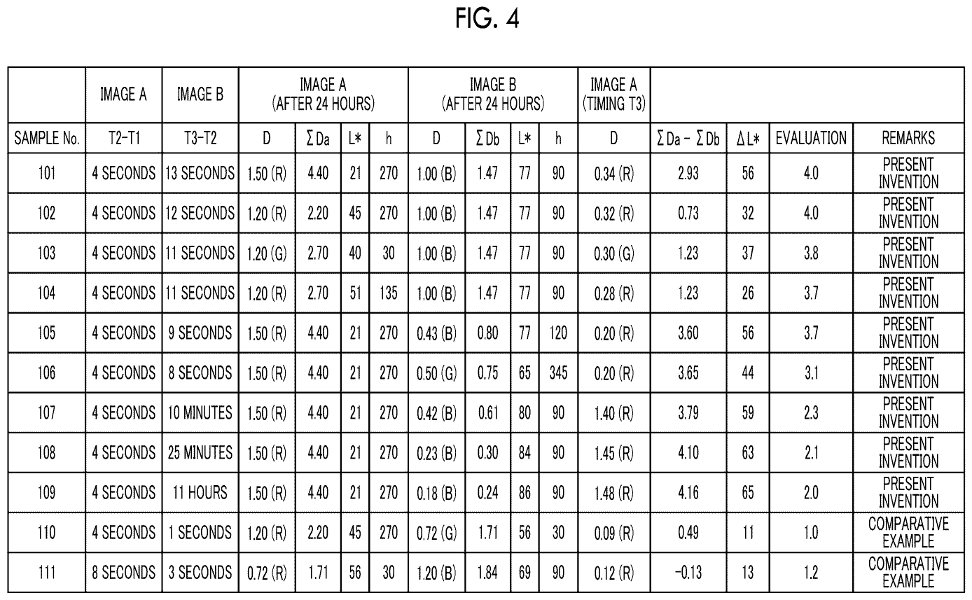

FIG. 4 is a chart illustrating characteristics of a plurality of observation image samples corresponding to the observation image according to Example 1.

In the formation of the observation image sample 101, timings required for the image appearance in step (2) and step (3) are changed as illustrated in FIG. 4. Characteristic values of the density, the brightness, and the hue of each image at that time are also illustrated in FIG. 4.

### Formation of Observation Image Samples 110 and 111 for Comparison

An image forming method for comparison will be described using the formation of the observation image samples 109 and 110 as an example.

In the preparation of the observation image sample 110, a condition in which the image appearance recognition timing does not satisfy the range of the present invention is set as illustrated in FIG. 4. Characteristic values of the density, the brightness, and the hue of each image at that time are also illustrated in FIG. 4.

### Sensory Evaluation of Image Appearance

In the formation of these observation image samples 101 to 111, the appearance of the image after the start of development is observed, and whether or not the appearance of the image A and the appearance of the image B are clearly distinguished and recognized is evaluated by 10 examinees in the following 4 ranks.

Rank 4: The appearance of the image A and the appearance of the image B are sufficiently distinguished and recognized, the image B also has a sufficiently high density, and the final image is also sharp. (4 points)

Rank 3: The appearance of the image A and the appearance of the image B are distinguished and recognized, the image B also has a sufficiently high density, and the final image is also sharp. (3 points)

Rank 2: The appearance of the image A and the appearance of the image B are distinguished and recognized. On the other hand, the image B has a low density and is a little weak as an image. (2 points)

Rank 1: It is difficult to distinguish and recognize the appearance of the image A and the appearance of the image B due to an impression that the image A and the image B are continuously formed. (1 point)

In FIG. 4, an average value by 10 persons is illustrated as an evaluation value.

As described above, from FIG. 4, in a case of using the image forming method of setting timings required for the image appearance of the image A and the image appearance of the image B according to the present invention, the observation image changes as the development progresses. Thus, the observation image is clearly distinguished and recognized in a first stage and a second stage.

### Example 2

An observation image is formed by creating an input image according to the following procedure, inputting the input image to the mono-sheet-type silver halide photographic photosensitive material for releasing and diffusion transfer of colorants, and performing development processing.

The photosensitive material is a photosensitive material obtained by changing the photosensitive material according to Example 1 as follows.

A liquid obtained by mixing coating compositions of a yellow color material layer, a magenta color material layer, and a cyan color material layer at a ratio of application amounts is divided into three equal parts and is applied such that the application amounts for the three layers are the same at a position of each color material layer of the three layers. The photosensitive material obtained in this way includes a red-sensitive emulsion layer (lower layer), a green-sensitive emulsion layer (middle layer), and a blue-sensitive emulsion layer (upper layer) in the order of proximity to the colorant receiving layer. In the photosensitive material, due to development of the photosensitive silver halide emulsion layer of each color, three colorants of yellow, magenta, and cyan are transferred at the same time. Thus, in a case where the photosensitive material is used, an almost black-and-white monochrome color image in which three colors are mixed is formed.

### Generation of Input Image

FIG. 3 is a conceptual diagram illustrating an observation image according to Example 2. The observation image illustrated in FIG. 3 is in a form of “question” and “answer”.

Question: what's the weather tomorrow?

Answer: cloud mark icon

First, the following steps are performed as step (1).

Among a plurality of original images, a text information image of “What is the weather tomorrow?” is selected as an image for the image A, and an image of “cloud mark icon” is selected as an image for the image B. Thus, the images which are to be used for the image A and the image B are determined.

Subsequently, the following steps are performed as step (2).

In the image for the image A, for the text information image of “What is the weather tomorrow?”, the layers to be developed are set such that conditions of the timings T1 and T2 required for the image appearance of the image A are satisfied, and an input image for the photosensitive material is created such that development is performed.

Specifically, the text information is expressed in bold in MSP Gothic font such that the following conditions are met.
T2−T1 4 seconds
D 1.50 (density of G)
development layer upper layer/middle layer/lower layer

The contributions of the three photosensitive layers in density are respectively set to 0.5. Specifically, a condition for imparting a density of 0.50 is determined by exposure and development of the lower layer. Thereafter, in addition to the condition, a condition for imparting a density of 1.0 is determined by exposure and development of the middle layer, and further, a condition for imparting a density of 1.5 is determined by exposure and development of the upper layer. In order, exposure conditions are set. In a case of forming an image by development processing of a plurality of layers in another sample, exposure conditions are similarly determined in order from the lower layer.

Subsequently, the following steps are performed as step (3).

In the image for the image B, for the image of “cloud mark icon”, the layers to be developed are set such that a condition of the timing T3 required for the image appearance of the image B is satisfied, and input image information for the photosensitive material is created such that development is performed.
T3−T2 10 seconds
D 0.50 (density of G)
development layer only upper layer

Subsequently, the following steps are performed as step (4).

An input image for the photosensitive material is created by arranging and combining the image obtained in step (2) and the image obtained in step (3) such that the images have appropriate sizes and a positional relationship on the observation image screen.

### Formation of Observation Image Sample 201 Using Photosensitive Material

The input image obtained in this way is input to the mono-sheet-type silver halide photographic photosensitive material for releasing and diffusion transfer of colorants by using a multi light-emitting head in which light emitting diodes of three colors of R, G, and B are arranged in a main scanning direction according to a method described in JP1999-344772A (JP-H11-344772A).

The developer is applied at 25° C. and with a thickness of 62 μm, and development processing is performed. The input image information is converted into colorant image information, and thus an observation image sample 201 is formed.

### Formation of Observation Image Samples 202 to 204 Using Photosensitive Material

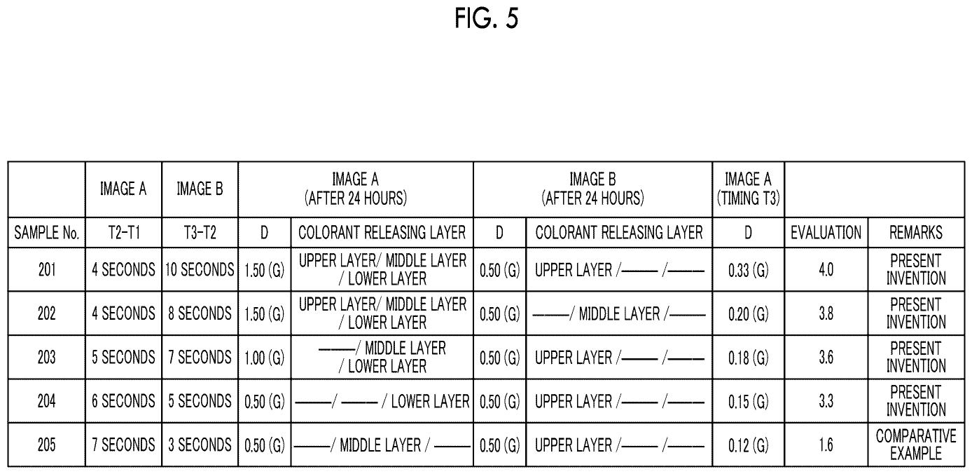

FIG. 5 is a chart illustrating characteristics of a plurality of observation image samples corresponding to the observation image according to Example 2.

In the formation of the observation image sample 201, timings required for the image appearance in step (2) and step (3) are changed as illustrated in FIG. 5. The density of each image at that time and the development layer are also illustrated in FIG. 5.

### Formation of Observation Image Sample 205 for Comparison

In the preparation of the observation image sample 205, a condition in which the image appearance recognition timing does not satisfy the range of the present invention is set as illustrated in FIG. 5. The density of each image at that time and the development layer are also illustrated in FIG. 5.

In the formation of these observation image samples 201 to 205, the appearance of the image after the start of development is observed, and whether or not the appearance of the image A and the appearance of the image B are clearly distinguished and recognized is evaluated by 10 examinees according to the same evaluation standard as in Example 1. In FIG. 5, an average value by 10 persons is illustrated as an evaluation value.

As described above, from FIG. 5, in a case of controlling a position of the colorant releasing layer from which the colorant is released by development processing and using the image forming method of setting timings required for the image appearance of the image A and the image appearance of the image B according to the present invention, the observation image changes as the development progresses. Thus, a message that can be read from the observation image is clearly distinguished and recognized in a first stage and a second stage.

### Example 3

An observation image is formed by creating an input image according to the following procedure, inputting the input image to the mono-sheet-type silver halide photographic photosensitive material for releasing and diffusion transfer of colorants, and performing development processing.

As the photosensitive material, the same photosensitive material as the photosensitive material used in Example 1 is used.

### Creation of Input Image

by using a captured landscape photograph as one original image (base image), input image processing including the following steps is performed on the base image. The base image is an image in which a silhouette of a Japanese temple building appears against a background of cherry blossoms in full bloom.

The following steps are first performed on the base image as step (1).

From the base image, a portion of “a silhouette of a Japanese temple building” is selected as an image region for the image A, and a portion of “cherry blossoms in full bloom” is selected as an image region for the image B. Thus, the images which are to be used for the image A and the image B are determined.

Subsequently, the following steps are performed as step (2).

In the image for the image A, for the image of the portion of “a silhouette of a Japanese temple building”, characteristic values of the density, the brightness, and the hue of the final observation image are set such that conditions of the timings T1 and T2 required for the image appearance of the image A are satisfied. An input image for the photosensitive material is created such that the set final image density is expressed by the photosensitive material.

Specifically, the base image has a slightly brownish gray color in which L* is 58. In a case where the density is increased while maintaining the hue angle, the base image has a dark gray color in which L* is 21.

Subsequently, the following steps are performed as step (3).

In the image for the image B, for the portion of “cherry blossoms in full bloom”, characteristic values of the density, the brightness, and the hue of the final observation image are set such that a condition of the timing T3 required for the image appearance of the image B is satisfied. An input image for the photosensitive material is created such that the set final image density is expressed by the photosensitive material.

Specifically, the base image has a clear pink color in which L* is 60. In a case where the brightness is increased while maintaining the hue angle, the base image has a color in which L* is 65.

Subsequently, the following steps are performed as step (4).

An input image for the photosensitive material is created by recombining the image obtained in step (2) and the image obtained in step (3).

### Formation of Observation Image Sample 301 Using Photosensitive Material

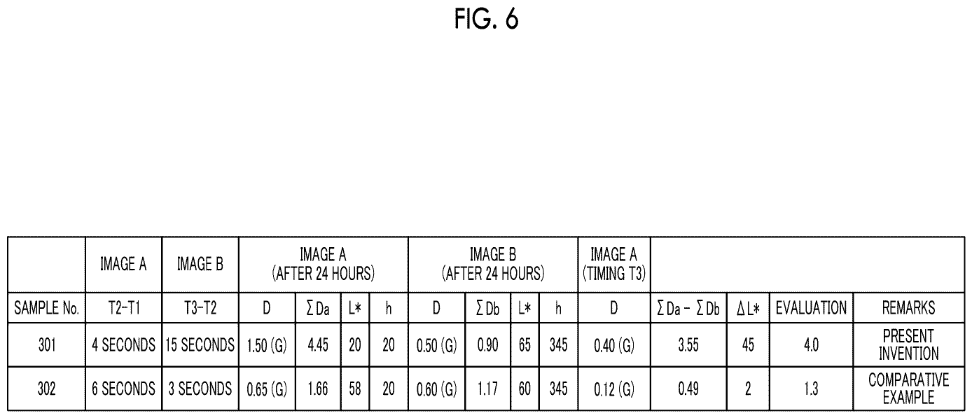

FIG. 6 is a chart illustrating characteristics of a plurality of observation image samples corresponding to the observation image according to Example 3.

The input image obtained in this way is input to the mono-sheet-type silver halide photographic photosensitive material for releasing and diffusion transfer of colorants, the photosensitive material being an auto-positive photosensitive material, by using a multi light-emitting head in which light emitting diodes of three colors of R, G, and B are arranged in a main scanning direction according to a method described in JP1999-344772A (JP-H11-344772A).

The developer is applied at 25° C., and development processing is performed. The input image information is converted into colorant image information, and thus an observation image sample 301 is formed. Characteristic values of the density, the hue, and the brightness of each image at that time are also illustrated in FIG. 6.

### Formation of Observation Image Sample 302 for Comparison

An observation image sample 302 is formed in the same manner except that the base image is used as it is as an input image. Characteristic values of the density, the hue, and the brightness of each image at that time are also illustrated in FIG. 6.

In the formation of these observation image samples 301 and 302, the appearance of the image after the start of development is observed, and whether or not the appearance of the image A and the appearance of the image B are clearly distinguished and recognized is evaluated by 10 examinees according to the method described in Example 1. In FIG. 6, an average value by 10 persons is illustrated as an evaluation value.

As described above, from FIG. 6, in a case where the base image is used as it is, a particular effect on the appearance of the image is not recognized. On the other hand, in a case where the image forming method according to the present invention is used, the observation image changes as the development progresses, and thus, the observation image is clearly distinguished and recognized in a first stage and a second stage.

In the Example, steps (1) to (4) are sequentially performed. On the other hand, in a case of reading information of the base image, the formation of the image is determined in advance, and the image is mapped to the color gamut satisfying the conditions of the image A and the image B. Therefore, these steps can be performed at the same time.

### Example 4

Hereinafter, an example of creating images of a quiz and an answer to the quiz will be described.

A template is used as the original image, and the image information includes a text and an image.

### Example of Quiz

(a) Question: What temple is Shotoku established?
(b) Correct answer: Horyu Temple

### Additional Image

(c) Portrait photograph of Prince Shotoku
(d) Supplementary explanation text information
(e) Photograph of a five-storied pagoda of Horyu Temple

### Collection of Images

The images of the portions (a) to (e) and text information are prepared. The print software for image appearance recognition speed control is started, and the images are transmitted to a personal computer (PC).

### Image Processing Step

### Step (1)

According to a format of the quiz, “question portion=(a)” is set for the image A in which the image recognition speed is high, and “correct answer portion=(b)” is set for the image B in which the image recognition speed is low.

In the answer portion of the additional image, the image of the portion (c) related to the question is used for the image A, and the images of the portions (d) and (e) related to the answer are used for the image B.

A set of the images of the portions (a) to (e) can be used as one template for a quiz-type image configuration.

### Steps (2) and (3)

The density, the brightness, and the hue of each image are mapped such that the image A and the image B satisfy the image appearance recognition timings, and the image information of each image is temporarily determined. Based on the temporarily determined image information, a demo moving image of the appearance of the observation image in a case where the observation image is obtained from the photosensitive material may be displayed.

With reference to the demo moving image, whether to set the difference in the image appearance speed to be larger or smaller is adjusted as appropriate. (That is, a mapping pattern of the photographic image may be learned in advance using the past image data, and a typical pattern may be displayed as an image by the system.)

For example, among pieces of the information of the portions (b), (d), and (e) which are assigned for the image B and related to the correct answer, the image of the portion (e) has a later appearance timing than those of the other images.

By setting the image appearance timing in this way, in the image B, it is possible to make the image information indicating the text information of Horyu temple appear in order. Thus, it is possible to configure a multi-stage image appearance.

### Step (4)

The steps are repeated, and positions of parts of the images of the portions (a) to (e) are adjusted. Thereby, a final input image is created.

### Output of Observation Image

The input image for output is transmitted from the PC to an instant photo printer. The printer converts the input image into exposure data and exposes the photosensitive material. Subsequently, the photosensitive material is extruded from the printer, and at that time, a development treatment liquid is applied on the photosensitive material.

The user observes a process of formation of an image on the observation surface of the photosensitive material.

### Example 5

An input image is created according to the following procedure with a purpose of forming an observation image having a pattern similar to pattern of the observation image sample 301 according to Example 3. Except that, the observation image is formed and evaluated in the same manner as the formation of the observation image sample 301 according to Example 3.

### Creation of Input Image

According to the following steps, an input image is created by providing a large liquid crystal display in a background of a wooden panel, preparing capturing environments, preparing a subject, and capturing the subject.

First, the following steps are performed as step (1).

A portion of “a silhouette of a Japanese temple building” is selected as an image region for the image A, and a portion of “cherry blossoms in full bloom” is selected as an image region for the image B. Thus, the image regions which are to be used for the image A and the image B are determined.

Subsequently, the following steps are performed as step (2).

A wooden panel representing a silhouette of the Japanese temple building is created. The wooden panel is colored and illuminated as appropriate such that the appearance recognition timing of the image satisfies the condition of the image A.

Subsequently, the following steps are performed as step (3).

In the image for the image B, the portion of “cherry blossoms in full bloom” is displayed on a liquid crystal display and the hue, the density, and the brightness of the image are adjusted such that the appearance recognition timing of the image satisfies the condition of the image B.

Subsequently, the following steps are performed as step (4).

The liquid crystal display prepared in step (3) is appropriately disposed in the background of the wooden panel provided in step (2), fine adjustment such as illumination is performed, and conditions of the final subject to be captured are determined. The subject prepared in this way is captured by a digital camera, and a captured image is used as an input image.

An image is formed and evaluated according to the method by using the created input image. As a result, the observation image changes as the development progresses. Therefore, the observation image is clearly distinguished and recognized in a first stage and a second stage.

Further, in a case where a program including a series of processing from capturing of a photograph to output instruction of an image is provided as smartphone application software, the series of processing can be easily performed by a single smartphone.

### Third Embodiment of Image Forming Method

In a third embodiment of the image forming method according to the present invention, the observation image is an image obtained by diffusing and transferring a solid-dispersed anionic colorant into a colorant receiving layer by a treatment using an alkaline liquid and immobilizing the anionic colorant in the colorant receiving layer, the observation image being drawn using the anionic colorant in a plurality of layer regions having different distances from the colorant receiving layer.

In step (2) and step (3) of creating the first drawing condition and the second drawing condition for drawing and forming an image pattern by using the precursor of the image forming material, a drawing condition for drawing the image pattern using the anionic colorant in the plurality of regions (first image region and second image region) having different distances from the colorant receiving layer is created. Further, the “chemical reaction” for forming an observation image by causing a chemical reaction to progress on the precursor is a treatment using an alkaline liquid.

An amount of a colorant per unit area that is released from a solid-dispersed-colorant-containing layer closest to the colorant receiving layer in the highest density portion of the image A of the first image region is greater than an amount of a colorant per unit area that is released from the solid-dispersed-colorant-containing layer in the highest density portion of the image B of the second image region.

Here, the solid-dispersed anionic colorant may be in a solid state or an amorphous state at room temperature, and have an equivalent sphere diameter of approximately 0.05 μm to 1.0 μm. The solid-dispersed anionic colorant has such a size, and thus, in a solid-dispersed state, diffusion of molecules in a medium is prevented. For example, with respect to such a solid-dispersed colorant, the materials described in JP3619288B, JP3545680B, JP3264587B, and JP1994-148802A (JP-H6-148802A) may be used.

For example, as a solid-dispersed anionic colorant, a compound I-1, a combined colorant (1), and a combined colorant (2) exemplified in JP3619288B, colorants 1 and 11 exemplified in JP3545680B, and colorants 1, 4, 5, 6, and 20 exemplified in JP3264587B may be used.

A diffusion rate may be adjusted by a molecular weight of the colorant, a hydrophilicity, a hydrophobicity, a mother nucleus structure, and the like.

In the present embodiment, a diffusion distance to the colorant receiving layer may be adjusted by drawing an image using the solid-dispersed colorant at a plurality of positions having different distances from the colorant receiving layer. The diffusion distance may be adjusted by providing, using a binder such as gelatin, on a surface on which initial drawing is performed using the solid-dispersed colorant, an interlayer which has a certain thickness or intentionally different thicknesses depending on the region, and further performing, on a front surface of the interlayer, second drawing using the solid-dispersed colorant. The diffusion distance may be adjusted by adjusting the thickness of the interlayer. A plurality of interlayers that can be used for adjusting the diffusion distance may be provided, and drawing may be performed on a front surface of each of the plurality of interlayers using the solid-dispersed colorant. Preferably, a plurality of solid-dispersed colorants having different colors may be used.

In addition, a rate at which the colorant is dissolved from the solid-dispersed state to a monomolecular state may be adjusted by a particle size of the solid-dispersed colorant. That is, since dissociation and dissolution of the colorant occur on front surfaces of the particles, by reducing the particle size, a front surface area per unit colorant amount can be increased. Thus, a dissolution rate can be increased. In addition, the dissolution rate can be controlled by adding an adsorptive substance to the particle surface.

A specific configuration example of the present embodiment will be described below.

On a substrate obtained by applying the photosensitive element No. 101 described in JP2000-112096A from a back layer to a fourth layer, an interlayer having the same composition as a composition of a third layer is provided as a fifth layer such that the gelatin coating amount is 0.29 g/m². On the interlayer, the image A of the first image region is drawn by an ink jet apparatus using the solid-dispersed colorant (the compound I-1 exemplified in JP3619288B). On the image A, as a sixth layer, an interlayer having the same composition as a composition of the third layer is provided such that the gelatin coating amount is 2.50 g/m². On the sixth layer, the image B of the second image region is drawn by an ink jet apparatus using the solid-dispersed colorant. On the image B, as a seventh layer, an interlayer having the same composition as a composition of the third layer is provided such that the gelatin coating amount is 2.50 g/m². A container that can be broken by pressure is filled with an alkaline treatment liquid from which potassium sulfite is removed, and a mono-sheet-type material for releasing and diffusion transfer of colorants is formed according to the method described in JP1995-159931A (JP-H7-159931A).

The alkaline treatment liquid is applied at 25° C. with a thickness of 62 μm. Thereafter, the appearance of the image is observed. The image A of the first image region appears first, and the image B of the second image region appears later.

### Fourth Embodiment of Image Forming Method

In a fourth embodiment of the image forming method according to the present invention, the observation image is formed as a colored colorant image by drawing, on the support, the image pattern using an ink composition containing an oxidative coloring colorant and a reducing agent which is oxidized by oxygen and oxidizing the reducing agent and the colorant by oxygen in the atmosphere.

In step (2) and step (3) of creating the first drawing condition and the second drawing condition for drawing and forming an image pattern using a precursor of the image forming material, compositions of the ink composition and drawing conditions are created. Further, the “chemical reaction” for forming an observation image by causing a chemical reaction to progress on the precursor is oxidation by oxygen in the atmosphere.

Drawing is performed such that the image A of the first image region has a reducing activity lower than a reducing activity of the image B of the second image region.

Examples of the oxidative coloring colorant of the precursor of the image forming material according to the present embodiment include a material of which the color is changed from substantially colorless to a colored color by oxidation, and a material of which the color is changed to another color by oxidation. In a case where the support itself for forming the image without the precursor of the image forming material is colored, even though the material before oxidation is colored, the precursor of the image forming material may be inconspicuous to some extent. Preferably, in a case where the material is less colored in a state before oxidation, whiteness of the support can be increased. Thus, an observation image having a large change in density can be formed. Preferably, the density of the oxidative coloring colorant in a visible region is doubled or more, and more preferably three times or more by oxidation. Here, the density in the visible region represents a total value of the densities of B, G, and R, and represents the density measured under a filter condition of status A in a state where a D65 light source is used.

As such a material, a material known as a leuco colorant may be used. Examples of the leuco colorant that can be used in the present embodiment include an indian aniline leuco colorant, an indamine leuco colorant, a triphenylmethane leuco colorant, a triarylmethane leuco colorant, a styryl leuco colorant, an N-acyloxazine leuco colorant, an N-acylthiazine leuco colorant, an N-acyldiazine leuco colorant, a xanthene leuco colorant, and the like.

In addition, as a colorant of which the color changes by redox, a methylene blue, a neumethylene blue, a phenosafranin, a laus violet, a methylene green, a neutral red, an indigo carmine, an acid red, a safranin T, a capri blue, a nile blue, a diphenylamine, a xylene cyanol, a nitrodiphenylamine, a ferroin, an N-phenylanthranyl acid, and the like may be used. More preferably, a colorant such as a methylene blue or a phenosafranin that becomes colorless in a reduced state may be used.

As the oxidative coloring colorant, in addition to the organic material, an inorganic material or a metal complex material is used. As the inorganic material, for example, NiO (nickel oxide), Cr₂O₃ (chromium (III) oxide), MnO₂ (manganese dioxide), or CoO (cobalt oxide) is used. As the metal complex material, for example, a ferrocene, a Prussian blue, or a tungsten oxalic acid complex is used.

In the present embodiment, an observation image is formed by oxidation of the precursor of the image forming material. The oxidation method may be roughly classified into the following two methods.

A method in which oxidation is promoted by oxygen in the atmosphere in the vicinity of the image forming material, and a method in which an oxidative material is present in the vicinity of the image forming material and oxidation is promoted by a chemical reaction with the oxidative material may be used. Preferably, from a viewpoint of safety of the image forming material and simplification of the system, oxidation using oxygen in the air may be used.

As a method of controlling the oxidation rate of the precursor of the image forming material on the support and controlling the rate of the image appearance, a method of delaying an oxidation reaction by adjusting an amount and a type of a reducing compound that delays oxidation by oxygen in the atmosphere may be used.

As a typical reducing agent, dihydroxybenzenes (for example, hydroquinone, hydroquinone monosulfonate), 3-pyrazoridones (for example, 1-phenyl-3-pyrazolidone, 1-phenyl-4-methyl-4-hydroxymethyl-3-pyrazolidone), aminophenols (for example, N-methyl-p-aminophenol, N-methyl-3-methyl-p-aminophenol), ascorbic acid and isomers and derivatives of ascorbic acid may be used alone or in combination.

More preferably, ascorbic acid, hydroquinone potassium monosulfonate, or sodium hydroquinone monosulfonate may be used.

In addition, in combination or alone with the reducing agent, sodium sulfite, hydroxylamines, saccharides, o-hydroxyketones, or hydrazines may be used as a reducing agent or a retaining agent for the reducing agent. From a viewpoint of safety to the human body, preferably, saccharides may be used, and rutin and derivatives of the rutin known as flavonoid compounds may be used.

These reducing compounds are allowed to coexist with the precursor of the image forming material. Thus, an ink composition that is kept in a state where oxidation does not proceed is prepared, and drawing may be performed on the support using the ink composition. The method of controlling the oxidation rate of the precursor of the image forming material by changing the reducing activity for each image region can be achieved by properly using, for each image region, a plurality of types of the ink compositions in which the amount and the type of the reducing compound in the ink composition are changed. In addition, by drawing, on the support, an image pattern using an ink composition in which only the reducing compound is dissolved without the precursor of the image forming material and controlling the application amount and the type of the reducing agent, it is possible to change the reducing activity depending on the image region. In a case of using an ink composition without the precursor of the image forming material to control the reducing activity depending on the image region, as a timing for application to the support, a timing before the ink composition containing the precursor of the image forming material is applied, a timing when the ink composition is applied, or a timing after the ink composition is applied may be used.

In addition to oxidation by air, in order to control the oxidation rate of the precursor of the image forming material on the support and control the rate of the image appearance, it is possible to change the amount of the oxidizing agent supplied to the support or change the amount of catalyst for changing the activity of the oxidation reaction progress. For example, these components can be changed and applied for each image region on the support. As an example of an oxidizing agent, preferably, hydrogen peroxide (water) may be used because hydrogen peroxide does not leave colored substances or dangerous substances after the reaction even in a case where hydrogen peroxide remains on the support. Preferably, in order to change the activity of the oxidation reaction progress, pH may be adjusted for each image region by using an acid or an alkali.

A configuration example of a specific material is described below.

The following example is an example in which a difference in the air oxidation rate of the oxidative coloring colorant is given by changing the amount of the reducing agent that prevents oxidation by air coexisting with the colorant.

Drawing is performed on a paper support by an ink jet apparatus using two types of inks including an ink for an image having a high image appearance speed and an ink for an image having a low image appearance speed.

As the ink for the image A of the first image region, an ink obtained by adding ascorbic acid to a methylene blue aqueous solution until a color of the oxidant disappeared and further adding ascorbic acid having the same mass as the mass of the ascorbic acid required for disappearance is used. For the image B of the second image region, an ink obtained by adding ascorbic acid in an amount three times as much as the ascorbic acid used in the ink for the image A is used. In a case of observing the drawn image indoors, after the image A appears, the image B appears, and two regions having different image appearance speeds are observed.

### Fifth Embodiment of Image Forming Method

In a fifth embodiment of the image forming method according to the present invention, the observation image is formed as an image of metallic silver fine particles by reducing an image, which is drawn on the support using an ink composition containing silver ions, by a reducing agent.

In step (2) and step (3) of creating the first drawing condition and the second drawing condition for drawing and forming an image pattern using a precursor of the image forming material, compositions of the ink composition for imparting a reducing activity and drawing conditions are created. Further, the “chemical reaction” for forming an observation image by causing a chemical reaction to progress on the precursor is reduction.

Drawing is performed such that the image A of the first image region has a reducing activity higher than a reducing activity of the image B of the second image region.

The image forming material according to the aspect will be described.

Examples of an ink material containing silver ions according to the present embodiment include a silver nitrate aqueous solution. Further, a Tollens' reagent prepared by adding aqueous ammonia to a silver nitrate aqueous solution may also be used.

These materials are colorless and transparent, and are preferable because the support is not colored immediately after drawing is performed on the support. As a silver ion reducing agent, preferably, the reducing agent mentioned in the fourth embodiment of the image forming method may be used. More preferably, ascorbic acid, hydroquinone potassium monosulfonate, or sodium hydroquinone monosulfonate may be used. Further, in a case where a Tollens' reagent is used, preferably, a reducing saccharide may be used.

The method of changing the reducing activity for each image region can be achieved by properly using, for each image region, a plurality of types of the ink compositions in which the amount and the type of the reducing compound in the ink composition are changed, or by changing an application amount of the ink composition. In a case of using the ink composition, as a timing for application to the support, a timing before the ink composition containing the precursor of the image forming material is applied, a timing when the ink composition is applied, or a timing after the ink composition is applied may be used. Further, in a case where a time for mixing the silver ion and the reducing agent in a liquid state is long, the reaction progress rate is high. From this point, by increasing the absolute amount of water application or using a moisturizer for delaying water volatilization, the reducing activity can be increased.

A configuration example of a specific image forming material is described below.

The following example is an example of imparting a difference in image appearance recognition timing by changing the reducing activity for each image region in a case of reducing the silver ions of silver nitrate and changing a color of silver nitrate to a black color.

From the final observation image, two regions (first image region and second image region) having different image appearance speeds are divided as candidates.

An ink is prepared using ascorbic acid as the reducing agent and one type of flavonoid rutin as a stabilizer for ascorbic acid. In a case where the adjusted ink is applied onto the paper support by an ink jet apparatus, the application amount of ascorbic acid is adjusted such that the amount of ascorbic acid applied to the image A, which appears relatively earlier, is greater than the amount of ascorbic acid applied to the image B. In this way, two regions having different reducing activities are formed.

Thereafter, using the silver nitrate aqueous solution ink, an observation image is drawn on a paper support containing a reducing agent by an ink jet apparatus.

The drawn observation image is observed. As a result, an image of gradually blackened silver is obtained from a white background. After the appearance of the image A, the image B appears. Thus, two regions having different image appearance speeds are observed.

In the present invention, the fourth embodiment and the fifth embodiment of the image forming method may be used in combination. For example, the silver nitrate ink of the fifth embodiment may be used for the image A, and the methylene blue ink of the fourth embodiment may be used for the image B.

### Image Forming Apparatus

As the image forming apparatus according to the present invention, a smartphone, a digital camera, a mobile information terminal with a camera, a game device, a tablet terminal, or the like may be used.

Hereinafter, a case where a smartphone is used as the image forming apparatus will be described.

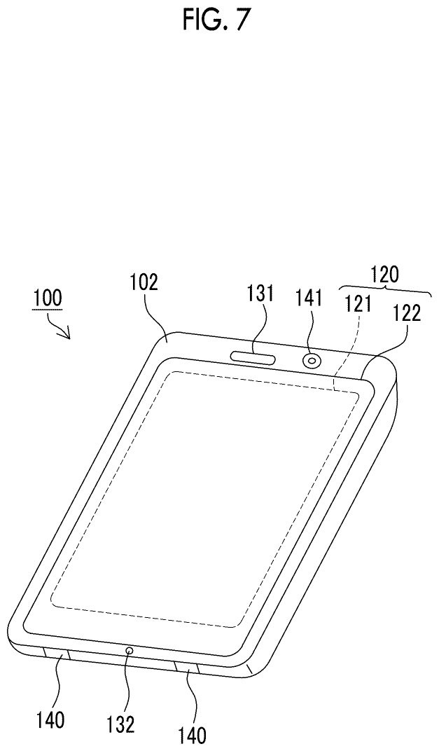

FIG. 7 is a diagram illustrating an appearance of a smartphone as an embodiment of an image forming apparatus according to the present invention.

The smartphone 100 illustrated in FIG. 7 includes a flat plate housing 102, a display panel 121 as a display unit that is provided on one surface of the housing 102, and a display input unit 120 in which an operation panel 122 as an input unit is integrated. Further, the housing 102 includes a speaker 131, a microphone 132, an operation unit 140, and a camera unit 141.

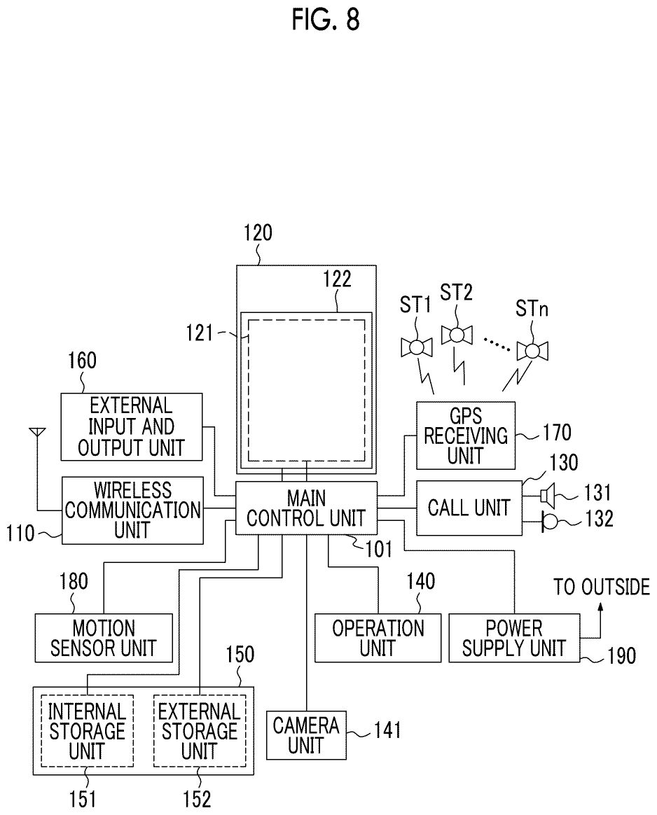

FIG. 8 is a block diagram illustrating an internal configuration of the smartphone illustrated in FIG. 7.

As illustrated in FIG. 8, as main components of the smartphone 100, a wireless communication unit 110, the display input unit 120, a call unit 130, the operation unit 140, the camera unit 141, a storage unit 150, an external input and output unit (output unit) 160, a global positioning system (GPS) receiving unit 170, a motion sensor unit 180, a power supply unit 190, and a main control unit 101 are provided. Further, as a main function of the smartphone 100, the smartphone 100 has a wireless communication function of performing mobile wireless communication via a base station apparatus and a mobile communication network.

The wireless communication unit 110 performs wireless communication with the base station apparatus connected to a mobile communication network according to an instruction of the main control unit 101. The wireless communication unit 110 transmits and receives various file data such as voice data and image data, e-mail data, and the like, and receives web data, streaming data, and the like by using wireless communication.

The display input unit 120 is a so-called touch panel including the operation panel 122 provided on a screen of the display panel 121. Under a control of the main control unit 101, the display input unit 120 visually informs the user of information by displaying images (still images and moving images), text information, and the like, and detects a user's operation on the displayed information. The operation panel 122 is also referred to as a touch panel for convenience.

The display panel 121 uses a liquid crystal display (LCD), an organic electro-luminescence display (OELD), or the like as a display device. The operation panel 122 is a device that is provided to allow the user to visually recognize an image displayed on a display surface of the display panel 121 and detects one or a plurality of coordinates obtained by a finger operation or a stylus operation by the user. In a case where the device is operated by a finger operation or a stylus operation by the user, the operation panel 122 outputs a detection signal generated by the operation to the main control unit 101. Next, the main control unit 101 detects an operation position (coordinate) on the display panel 121 based on the received detection signal.

As illustrated in FIG. 7, the display panel 121 and the operation panel 122 of the smartphone 100 are integrated as one body and are provided as the display input unit 120. In this configuration, the operation panel 122 is disposed such that the display panel 121 is completely covered. In a case where the configuration is adopted, the operation panel 122 may have a function of detecting an operation of a user even in a region outside the display panel 121.

The call unit 130 includes a speaker 131 and a microphone 132, and is a unit that converts a user's voice input through the microphone 132 into voice data which can be processed by the main control unit 101 and outputs the voice data to the main control unit 101 and that decodes voice data received by the wireless communication unit 110 or the external input and output unit 160 and outputs the voice data from the speaker 131. Further, as illustrated in FIG. 7, for example, the speaker 131 and the microphone 132 may be provided on the same surface as the surface on which the display input unit 120 is provided.

The operation unit 140 is a hardware key using a key switch and the like, and receives an instruction from the user. For example, as illustrated in FIG. 7, the operation unit 140 is provided on a side surface of the housing 102 of the smartphone 100, and is a push button type switch that is turned on when pressed by a finger or the like and is turned off by a restoring force of a spring or the like when the finger is released.

The storage unit 150 is a unit that stores a control program and control data of the main control unit 101, various application software including an image forming program according to the present invention, address data associated with a name and a telephone number of a communication partner, transmitted/received e-mail data, web data downloaded by web browsing, and downloaded content data and that temporarily stores streaming data and the like.

Further, the storage unit 150 includes an internal storage unit 151 that is built in the smartphone and an external storage unit 152 including an attachable and detachable external memory slot. Each of the internal storage unit 151 and the external storage unit 152 included in the storage unit 150 is realized by using a storage medium such as a flash memory, a hard disk, a MultiMediaCard micro memory, a card type memory, a random access memory (RAM), and a read only memory (ROM).

The external input and output unit 160 serves as an interface between the smartphone 100 and all external apparatuses connected to the smartphone 100, and directly or indirectly connects the smartphone 100 to another external apparatus by communication (for example, a USB (universal serial bus), IEEE 1394, or the like) or by a network (for example, the Internet, a wireless local area network (LAN), Bluetooth (registered trademark), or the like).

Examples of the external apparatus connected to the smartphone 100 include, for example, a memory card or a subscriber identity module (SIM) card/user identity module (UIM) card connected via a card socket, a printer (including a printer for outputting an observation image according to the present invention) connected in a wired/wireless manner, a smartphone, a personal computer, and earphones. The external input and output unit 160 may be configured to transmit data transmitted from such an external apparatus to each component in the smartphone 100, or transmit data in the smartphone 100 to the external apparatus.

The GPS receiving unit 170 receives GPS signals transmitted from GPS satellites ST1, ST2 to STn according to an instruction of the main control unit 101, executes positioning calculation processing based on the received plurality of GPS signals, and acquires position information (GPS information) specified by a latitude, a longitude, and an altitude of the smartphone 100.

The motion sensor unit 180 includes, for example, a three-axis acceleration sensor, and detects a physical movement of the smartphone 100 according to an instruction of the main control unit 101. By detecting the physical movement of the smartphone 100, a movement direction and acceleration of the smartphone 100 are detected. The result of the detection is output to the main control unit 101.

The power supply unit 190 supplies electric power stored in a battery (not illustrated) to each unit of the smartphone 100 according to an instruction of the main control unit 101.

The main control unit 101 includes a microprocessor, operates according to a control program and control data stored in the storage unit 150, and collectively controls each unit of the smartphone 100. In addition, the main control unit 101 has a mobile communication control function for controlling each unit of a communication system and an application processing function to perform voice communication and data communication via the wireless communication unit 110.

The application processing function is realized by operating the main control unit 101 according to application software stored in the storage unit 150. Examples of the application processing function include, for example, an infrared communication function of performing data communication with an opposite apparatus by controlling the external input and output unit 160, an e-mail function of transmitting and receiving an e-mail, a web browsing function of browsing a web page, and an image forming function according to the present invention.

Further, the main control unit 101 has an image processing function such as displaying a video on the display input unit 120 based on image data (a still image or moving image data) such as received data or downloaded streaming data. The image processing function refers to a function in which the main control unit 101 decodes the image data, performs image processing on the decoding result, and displays an image obtained by the image processing on the display input unit 120.

Further, the main control unit 101 executes a display control for the display panel 121 and an operation detection control for detecting an operation of a user via the operation unit 140 and the operation panel 122.

By executing the display control, the main control unit 101 displays an icon for starting the application software, a software key such as a scroll bar, or a window for transmitting an e-mail.

Further, by executing the operation detection control, the main control unit 101 detects an operation of the user via the operation unit 140, receives an operation on the icon and a character string input in an input field of the window via the operation panel 122, or receives a scroll request for a display image via the scroll bar.

Under a control of the main control unit 101, the camera unit 141 may convert image data obtained by image capturing into, for example, compressed image data such as joint photographic experts group (JPEG), and record the image data in the storage unit 150 or output the image data via the external input and output unit 160 or the wireless communication unit 110. As illustrated in FIG. 7, in the smartphone 100, the camera unit 141 is provided on the same surface as the display input unit 120. On the other hand, a position of the camera unit 141 is not limited thereto, and the camera unit 141 may be provided on a rear surface of the housing 102 instead of a front surface of the housing 102 on which the display input unit 120 is provided. Alternatively, a plurality of camera units 141 may be provided on the housing 102.

Further, the camera unit 141 may be used for various functions of the smartphone 100. For example, the image acquired by the camera unit 141 may be used as an original image which is to be used for forming the observation image according to the present invention. In addition, text information which is input by the operation unit 140, position information acquired by the GPS receiving unit 170, and voice information acquired by the microphone 132 (text information obtained by performing voice-text conversion by the main control unit or the like may be used) may be recorded in the storage unit 150 or may be output via the external input and output unit 160 and the wireless communication unit 110.

The smartphone 100 having the configuration has the following functions in a case where the main control unit 101 executes an image forming program (print application software for image appearance timing control) according to the present invention, the program being downloaded from a server that is not illustrated.

### Photographing and Data Transmission

A photographic image is captured by the smartphone 100. The print application software for image appearance timing control (hereinafter, referred to as “the application”) is started and the photographic image is transmitted to the application.

### Image Processing Step

The original photographic image captured by the smartphone 100 is displayed.

### Step (1)

The subject in the photographic image is recognized and the photographic image is divided into segments by the application. According to patterns obtained by learning the divided segments in advance, approximately 6 patterns of combination candidates indicating which part of the photographic image is to be used for the image A and the image B are created. Among the patterns, two patterns having a high frequency of adoption are presented.

The user tentatively selects one from the two patterns. In a case the user selects a pattern different from the patterns proposed by the application, two of the following candidates are presented, and the user selects a desired pattern from the presented patterns. In a case where there is no desired pattern in the top 6 patterns, the user is asked to select images to be used for the image A and the image B from the images obtained by segmenting the image regions of the captured image.

### Step (2) and Step (3)

A version 1 of a final observation image is created by mapping the selected pattern with chromaticity points of an image in each segment such that the image appearance speed is satisfied.

For the version 1 of the image, a demo moving image of appearance is displayed. With reference to the demo moving image, whether to set the difference in the image appearance speed to be larger or smaller or whether to adjust the hue is selected.
(=make a difference in density larger by mapping of the photographic image)

The adjustment is repeated, and in a case of OK, each part is completed.

As an additional portion, a title may be added to the output image, or template information may be inserted into the output image. Information of the additional portion may be appropriately selected for the image A or the image B.

### Step (4)

An input image is completed by combining the image A and the image B and adding an image title as necessary.

### Output of Observation Image

The input image is transmitted from the smartphone 100 to an instant photo printer. The printer converts the input image into exposure data and exposes the photosensitive material. Subsequently, the photosensitive material is extruded from the printer, and at that time, a development treatment liquid is applied on the photosensitive material.

The user observes a process of formation of an image on the observation surface of the photosensitive material.

### Others

The hardware that realizes the image forming apparatus according to the present invention may be configured by various processors. The various processors include a central processing unit (CPU) which is a general-purpose processor that functions as various processing units by executing a program, a programmable logic device (PLD) such as a field programmable gate array (FPGA) which is a processor capable of changing a circuit configuration after manufacture, a dedicated electric circuit such as an application specific integrated circuit (ASIC) which is a processor having a circuit configuration specifically designed to execute specific processing, and the like.

One processing unit of the image forming apparatus may be configured by one of these various processors, or may be configured by two or more processors having the same type or different types. For example, one processing unit may be configured by a combination of a plurality of FPGAs or a combination of a CPU and an FPGA. Further, the plurality of processing units may be configured by one processor. As an example in which the plurality of processing units are configured by one processor, firstly, as represented by a computer such as a client and a server, a form in which one processor is configured by a combination of one or more CPUs and software and the processor functions as the plurality of processing units may be adopted. Secondly, as represented by a system on chip (SoC) or the like, a form in which a processor that realizes the function of the entire system including the plurality of processing units by one integrated circuit (IC) chip is used may be adopted. As described above, the various processing units are configured by using one or more various processors as a hardware structure. Further, as the hardware structure of the various processors, more specifically, an electric circuit (circuitry) in which circuit elements such as semiconductor elements are combined may be used.

Further, the present invention includes an image forming program, which causes a computer to function as an image forming apparatus according to the present invention by being installed in the computer, and a storage medium recording the image forming program.

Furthermore, the present invention is not limited to the above-described embodiment, and various modifications may be made without departing from the spirit of the present invention.

### EXPLANATION OF REFERENCES

100: smartphone
101: main control unit
102: housing
110: wireless communication unit
120: display input unit
121: display panel
122: operation panel
130: call unit
131: speaker
132: microphone
140: operation unit
141: camera unit
150: storage unit
151: internal storage unit
152: external storage unit
160: external input and output unit
170: GPS receiving unit
180: motion sensor unit
190: power supply unit
A, B: image
D: density
Dmin: minimum density
T1: image appearance recognition timing
T2: image appearance recognition timing
T3: image appearance recognition timing
h: hue angle

What is claimed is:

1. An image forming apparatus that causes a processor to generate an input image which is to be used for forming an observation image from original images, the observation image being obtained by drawing and forming an image pattern on a support using a precursor of an image forming material and causing a chemical reaction of the precursor to progress for image appearance and including at least one or more regions of a first image region and a second image region having different image appearance recognition timings,
wherein the processor is configured to perform
processing of acquiring one or a plurality of the original images,
processing of determining, from the acquired original images, a first image and a second image respectively corresponding to the first image region and the second image region according to an instruction from a user or by using artificial intelligence,
processing of creating a first drawing condition for the first image, the first drawing condition satisfying a condition of the image appearance recognition timing of the first image region,
processing of creating a second drawing condition for the second image, the second drawing condition satisfying a condition of the image appearance recognition timing of the second image region, and
processing of generating the input image based on the first image, the first drawing condition, the second image, and the second drawing condition.

2. The image forming apparatus according to claim 1,
wherein the processor is configured to draw and form the image pattern based on the input image using the precursor and form the observation image including the first image region and the second image region having different image appearance recognition timings.

3. The image forming apparatus according to claim 1, wherein
the image appearance recognition timing represents a timing when a highest density portion of the image region appears to be recognizable after a start of the chemical reaction, and
a difference between the image appearance recognition timing of the first image region and the image appearance recognition timing of the second image region is equal to or longer than 5 seconds and equal to or shorter than 12 hours.

4. The image forming apparatus according to claim 2, comprising
a printer that forms the observation image on an instant film in which a mono-sheet-type silver halide photographic photosensitive material for releasing and diffusion transfer of colorants is applied to the support by converting the input image into exposure data, exposing the instant film, and performing development processing,
wherein the processor outputs the input image to the printer, and causes the printer to form the observation image including the first image region and the second image region having different image appearance recognition timings on the instant film.

5. The image forming apparatus according to claim 4, wherein
the mono-sheet-type silver halide photographic photosensitive material for releasing and diffusion transfer of colorants includes at least a plurality of silver halide emulsion layers having different color sensitivities and a plurality of colorant releasing layers corresponding to each of the silver halide emulsion layers,
a colorant released by development processing is immobilized in a colorant receiving layer, and the observation image is formed, and
an amount of a colorant per unit area that is released from a colorant layer closest to the colorant receiving layer in a highest density portion of the first image region is greater than an amount of a colorant per unit area that is released from the colorant layer in a highest density portion of the second image region.

6. The image forming apparatus according to claim 4, wherein
assuming that, after the development processing is started, a timing when at least one of densities of three primary colors of a highest density portion of the first image region is equal to or higher than 0.04 is T1, and
a timing when at least one of densities of three primary colors of the highest density portion of the first image region is equal to or higher than 0.08 is T2,
the first image region is a region which satisfies the following Equation and in which a highest density among the densities of three primary colors of the highest density portion of the first image region after 24 hours from the start of the development processing is equal to or higher than 0.40 and lower than 3.0,
1 second≤T2−T1≤15 seconds, and
assuming that, after the development processing is started, a timing when at least one of densities of three primary colors of a highest density portion of the second image region is equal to or higher than 0.04 is T3,
the second image region is a region which satisfies the following Equation, in which the image appearance recognition timing is later than the image appearance recognition timing of the first image region, and in which a highest density among the densities of three primary colors of the highest density portion of the second image region after 24 hours from the start of the development processing is equal to or higher than 0.08 and lower than 2.5,
5 seconds≤T3−T2≤12 hours.

7. The image forming apparatus according to claim 4, wherein
a total ΣDa of density values of three primary colors of a highest density portion of the first image region after 24 hours from the start of the development processing satisfies the following Equation,
0.50≤ΣDa≤8.0,
a total ΣDb of density values of three primary colors of a highest density portion of the second image region after 24 hours from the start of the development processing satisfies the following Equation,
0.20≤ΣDb≤3.5, and
a difference between the total ΣDa and the total ΣDb satisfies the following Equation,
0.50≤ΣDa−ΣDb≤7.8.

8. The image forming apparatus according to claim 4, wherein
an L* value of a highest density portion of the first image region in a CIE LAB color space is equal to or larger than 5 and equal to or smaller than 70,
an L* value of a highest density portion of the second image region in a CIE LAB color space is equal to or larger than 60 and equal to or smaller than 95, and
a difference between the L* value of the first image region and the L* value of the second image region is equal to or larger than 15 and equal to or smaller than 80.

9. The image forming apparatus according to claim 4, wherein
a hue angle h of a highest density portion of the first image region is in any one range of 0° or more and 75° or less, 95° or more and 215° or less, or 235° or more and 340° or less,
a hue angle h of a highest density portion of the second image region is in any one range of 0° or more and 120° or less, 135° or more and 235° or less, or 330° or more and 360° or less, and
the hue angle h is an angle represented by h=arctan (b*/a*) in a CIE LAB color space.

10. The image forming apparatus according to claim 1, wherein
the observation image is an image obtained by diffusing and transferring a solid-dispersed anionic colorant into a colorant receiving layer by a treatment using an alkaline liquid and immobilizing the anionic colorant in the colorant receiving layer, the observation image being drawn using the anionic colorant in a plurality of layer regions having different distances from the colorant receiving layer,
in the processing of creating the first drawing condition and the second drawing condition, a drawing condition for drawing the observation image using the anionic colorant in the plurality of layer regions having different distances from the colorant receiving layer is created,
the chemical reaction is a treatment using the alkaline liquid, and
an amount of a colorant per unit area that is released from a solid-dispersed-colorant-containing layer closest to the colorant receiving layer in a highest density portion of the first image region is greater than an amount of a colorant per unit area that is released from the solid-dispersed-colorant-containing layer in a highest density portion of the second image region.

11. The image forming apparatus according to claim 1, comprising
an ink jet apparatus that draws the input image on the support,
wherein the processor is configured to cause the ink jet apparatus to form the observation image as a colored colorant image by drawing, on the support, the image pattern using an ink composition containing an oxidative coloring colorant and a reducing agent which is oxidized by oxygen and oxidizing the reducing agent and the colorant by oxygen in an atmosphere,
in the processing of creating the first drawing condition and the second drawing condition, compositions of the ink composition and drawing conditions are created,
the chemical reaction is oxidation by oxygen in the atmosphere, and
drawing is performed such that the first image region has a reducing activity lower than a reducing activity of the second image region.

12. The image forming apparatus according to claim 1, comprising
an ink jet apparatus that draws the input image on the support,
wherein the processor is configured to cause the ink jet apparatus to form the observation image as an image of metallic silver fine particles by reducing an image, which is drawn on the support using an ink composition containing silver ions, by a reducing agent,
in the processing of creating the first drawing condition and the second drawing condition, compositions of the ink composition for imparting a reducing activity and drawing conditions are created,
the chemical reaction is reduction, and
drawing is performed such that the first image region has a reducing activity higher than a reducing activity of the second image region.

13. An image forming apparatus comprising a processor and a display, the processor generating an input image which is to be used for forming an observation image from original images, the observation image being obtained by drawing and forming an image pattern on a support using a precursor of an image forming material and causing a chemical reaction of the precursor to progress for image appearance and including at least one or more regions of a first image region and a second image region having different image appearance recognition timings,
wherein the processor is configured to perform
processing of determining a plurality of regions of a subject, the plurality of regions including a first region and a second region respectively corresponding to the first image region and the second image region;
processing of preparing a first capturing environment for the first region, the first capturing environment satisfying a condition of the image appearance recognition timing of the first image region;
processing of preparing a second capturing environment for the second region, the second capturing environment satisfying a condition of the image appearance recognition timing of the second image region;
processing of generating the input image by capturing the subject once under the first capturing environment and the second capturing environment, and
at least one capturing environment of the first capturing environment or the second capturing environment is prepared by adjusting the display.

14. The image forming apparatus according to claim 13,
wherein the processor is configured to draw and form the image pattern based on the input image using the precursor and form the observation image including the first image region and the second image region having different image appearance recognition timings.

15. The image forming apparatus according to claim 13, wherein
the image appearance recognition timing represents a timing when a highest density portion of the image region appears to be recognizable after a start of the chemical reaction, and
a difference between the image appearance recognition timing of the first image region and the image appearance recognition timing of the second image region is equal to or longer than 5 seconds and equal to or shorter than 12 hours.
